(19) United States
(12) Patent Application Publication
(10) Pub. No.: US 2026/0278832 A1
(43) Pub. Date: Sep. 17, 2026

(54) METHOD FOR ASCERTAINING AT LEAST ONE DEGREE OF FREEDOM OF A CAMERA, COMPUTER PROGRAM, MACHINE-READABLE STORAGE MEDIUM, AND ELECTRONIC CONTROL UNIT OR AUTOMATION ASSEMBLY

(71) Applicant: Robert Bosch GmbH, Stuttgart (DE)

(72) Inventor: Joachim Frangen, Heilbronn (DE)

(21) Appl. No.: 19/168,643

(22) PCT Filed: Mar. 15, 2024
(86) PCT No.: PCT/EP2024/057052

§ 371 Date: Sep. 24, 2025

(30) Foreign Application Priority Data
Apr. 5, 2023 (DE) 10 2023 203 165.5

(51) Int. Cl. G06T 7/73; G01B 11/02; G01B 11/27; G06T 7/80

(52) U.S. Cl. CPC G06T 7/74; G01B 11/026; G01B 11/272; G06T 7/80; G06T 2207/10004; G06T 2207/20016; G06T 2207/30208; G06T 2207/30244

(57) ABSTRACT

A method for ascertaining at least one degree of freedom of a camera relative to a code arrangement from a camera image of the camera. The code arrangement has a point grid with a plurality of base symbols. A coarse position of the base symbols is encoded in the code arrangement. The base symbols define a first and a second main direction along the point grid. An angle of rotation phiz of the camera about the optical axis of the camera, a first and/or second local grid spacing of the point grid in the camera image in the first main direction or in the second main direction, a first and a local angular divergence of the point grid in the camera image in the first or second main direction, are determined as characteristic value. Based on the characteristic values, the three degrees of freedom of the camera are determined.

### FIELD

The present invention relates to a method for ascertaining at least one degree of freedom of a camera relative to a code arrangement in the camera image of the camera. The present invention also relates to a computer program, a machine-readable storage medium having the computer program and an electronic control unit or an automation assembly having the electronic control unit.

### BACKGROUND INFORMATION

In modern manufacturing and other applications, it is necessary to detect the position of a moving body relative to its surroundings. There are a variety of sensor systems for this purpose, such as path sensors, coded positions that are read out, etc. All the existing sensor systems have specific advantages for the particular application, which can be based on accuracy, simplicity, cost-effective integration, robustness or other properties.

German Patent Application No. DE 10 2016 216 221 A1 describes a method for positioning and/or determining the position of objects in a space and/or on a surface and uses a two-dimensional code arrangement. The two-dimensional code arrangement has base symbols, wherein the base symbols are arranged on a surface and the base symbols on the surface form a two-dimensional, periodic grid. Based on the code arrangement, the position of a camera relative to the code arrangement can be ascertained.

German Patent Application No. DE 10 2016 216 196 A1 describes a sensor system, wherein the sensor system uses the method for positioning and/or position determination of German Patent Application No. DE 10 2016 216 221 A1.

### SUMMARY

According to the present invention, a method for ascertaining at least one degree of freedom of a camera relative to a code arrangement from a camera image of the camera, an electronic control unit or an automation assembly having the electronic control unit, a computer program, and a machine-readable storage medium are provided. Preferred and/or advantageous embodiments of the present invention result from the disclosure herein.

The method according to the present invention is used to ascertain at least one degree of freedom of a camera relative to a code arrangement from a camera image of the camera.

The method is based on the method of German Patent Application No. DE 10 2016 216 221 A1 and/or German Patent Application No. DE 10 2016 216 196 A1, the disclosures of which are incorporated into the present disclosure by reference.

### Definition of Camera:

The camera comprises in particular an optical sensor unit (also referred to as an imaging sensor element, camera chip or image sensor) for recording the camera image, and imaging optics. In particular, the camera is designed as a color camera or as a black and white camera. The optical sensor unit is designed to provide a single camera image of a portion of the code arrangement and/or a sequence of camera images, for example in the form of a video. The camera has an image sensor as the optical sensor unit. The camera can comprise an objective, wherein the objective is preferably designed as a wide-angle lens. In particular, the camera implements a vanishing perspective and/or a central perspective. In particular, parallel edges are not shown parallel in the image when viewed at an angle, but optically merge into an imaginary point, the so-called vanishing point. In particular, the camera, in particular including the objective, implements a perspective distortion desired for the application.

### Definition of Optical Axis 5:

The imaging optics is ideally a rotationally symmetrical optical system, with the axis of symmetry being the optical axis. It is characterized by the fact that a light beam does not experience any deflection along the optical axis when passing through the optics.

### Definition of Image Center Point 7:

The intersection point of the optical axis 5 with the optical sensor unit 12 is referred to as the image center point 7. This can, but does not necessarily have to, coincide with the geometric center point of the optical sensor unit 12.

### Definition of Camera Image:

The camera image of the camera is designed in particular as a matrix which has pixels, such as 8-bit grayscale points or color points, at the matrix points.

### Definition of Code Arrangement:

The code arrangement can be imaged in particular by the camera, wherein, based on the camera image, e.g., the absolute position of a machine or a machine part can be measured in one to six degrees of freedom. In particular, the code arrangement is designed to be detected by the camera by contactless reading, wherein the camera can carry out multidimensional determination of the actual position by means of the contactless detection. Preferably, the two-dimensional code arrangement can be used in a production and/or testing facility in which workpieces and/or testing and/or work equipment must be positioned.

### Definition of Base Symbol:

The two-dimensional code arrangement comprises base symbols, wherein the base symbols are arranged on a surface and the base symbols on the surface form a two-dimensional periodic grid, a point grid. The base symbols are preferably geometric figures, for example circles, squares, triangles, or lines. Particularly preferably, the base symbols are formed as circles. The base symbols are also referred to as dots. They preferably represent digits of a number system. In particular, the two-dimensional code arrangement comprises at least two different base symbols. In a possible embodiment of the present invention, the two-dimensional periodic grid comprises empty spaces at grid locations that are not occupied by base symbols as parcel symbols.

The base symbols are arranged on the surface, wherein the surface can be a curved or a non-curved surface. For example, the surface is the floor of a production and/or testing facility. The base symbols are arranged in the surface to form a two-dimensional grid, wherein preferably the area centers of gravity of the base symbols form grid points in the point grid.

Definition of the point grid of the code arrangement:

The grid points are also referred to below as grid locations. In particular, the two-dimensional periodic point grid forms a two-dimensional lattice.

### Definition of Parcel:

The surface is preferably divided into similar, regularly arranged parcels, with the parcels having for example a square, rectangular, triangular, or hexagonal basic shape. Similar parcels are understood in particular to be parcels of the same size and/or shape. Preferably, each parcel comprises n base symbols. In particular, the parcels comprise an integer number of base symbols and, in particular, an even number of base symbols. Preferably, the parcels comprise more than ten base symbols, in particular more than twenty base symbols and in particular more than forty base symbols. Furthermore, the number of base symbols in a parcel is preferably less than one hundred. The parcels formed by the base symbols may be visually indicated in the code arrangement, such as by a border, or may not be visually indicated and form only a conceptual and/or logical unit.

### Definition of Parcel Region:

The parcels have at least a first and a second parcel region. An X parcel region comprises the first parcel region and a Y parcel region comprises the second parcel region. In particular, each parcel region occupies a contiguous surface or multiple distributed, non-contiguous sub-surfaces within the parcel.

Each parcel region comprises a plurality of base symbols. In particular, the X parcel region and the Y parcel region comprise the same number of base symbols. In particular, the at least two parcel regions are arranged in the parcel in such a way that they have a p-fold rotational symmetry with respect to the center point of the parcel as the point of rotation, wherein the p-fold rotational symmetry is, for example, a two-fold, three-fold or four-fold rotational symmetry.

### Definition of Parcel Symbol:

The parcels each have at least one parcel symbol, which represents a fixed reference point within each parcel. The parcel symbol allows the reading and/or decoding of the base symbols in a specified order. In particular, the parcel symbols are arranged regularly and/or periodically in the two-dimensional periodic grid of the base symbols. The parcel symbols can be located on or next to the grid points. In particular, the parcel symbols are each arranged at the same position within a parcel, such as in the center point of a parcel. The parcel symbols are, for example, different graphic elements than the base symbols, such as triangles, hexagons, or lines. Alternatively and/or additionally, the parcel symbols are represented by omitting one or more base symbols in a parcel. In a possible embodiment, the parcel symbol forms the symmetry point of the p-fold rotational symmetry of the parcel. In particular, the reading direction and/or decoding order, i.e., the order in which the base symbols must be read within the X parcel region and/or within the Y parcel region, is defined. Preferably, the reading direction and/or decoding order corresponds to the specification of which base symbols are to be read and/or decoded one after the other.

### Definition of Coding:

In the X parcel region, an X coordinate value is encoded by the base symbols and a Y coordinate value is encoded by the base symbols in the Y parcel region. In particular, the X coordinate value and the Y coordinate value are the coordinates of a base symbol in the parcel, wherein the coordinate is specified in a Cartesian coordinate system of the surface spanned by the base symbols. Alternatively and/or additionally, the X coordinate value and the Y coordinate value of a position within the surface can also be specified as coordinates in another coordinate system, such as an oblique-angle coordinate system, in cylindrical coordinates, or in spherical coordinates.

Definition of preferred embodiment of the point grid of the present invention:

In a particularly preferred embodiment of the present invention, the two-dimensional periodic grid is a rectangular grid, wherein the parcels are also rectangular. In particular, the rectangular grids and the rectangular parcels are square grids and/or square parcels. Preferably, the spacing of the base symbols along a length and width axis of the rectangular grid is equal. For example, for a square grid with square parcels, the number of base symbols in the X and Y directions of the planar two-dimensional periodic grid is the same. In particular, the X parcel region and the Y parcel region each consist of two spatially separated, rectangular sub-surfaces within a parcel, where the sub-surfaces have a longitudinal extension. The longitudinal extension of the sub-surfaces of the X parcel region is preferably perpendicular to the longitudinal extension of the sub-surfaces of the Y parcel region. Preferably, the area occupied by the X parcel region can be converted into the area occupied by the Y parcel region by a 90° rotation.

In a particularly preferred embodiment of the present invention, the periodic grid has a grid length and a grid width. The grid length extends in the X direction of a Cartesian coordinate system, and the grid width extends in the Y direction. The coordinate system thus formed assigns a uniquely determined position vector (X, Y) to each point of the coding surface.

In particular, a number of g consecutive base symbols forms an overall sequence. The overall sequence is entered into the X parcel regions, in particular in a plurality of parcels that are adjacent in the X direction. The entry of the base symbols is carried out in particular according to their order in the overall sequence, preferably in the ascending X direction of the parcels, within each parcel in a previously defined reading and/or decoding order in the X parcel regions. The number g is sufficiently large that the X parcel regions of all adjacent parcels in the X direction can be completely filled. In particular, g is greater than fifty, in particular greater than a thousand, and especially greater than one million. The contents of the X parcel regions of adjacent parcels in the Y direction are identical. It is particularly preferred that a portion of t consecutive base symbols in the overall sequence forms a sub-sequence. In particular, each portion of t consecutive base symbols of the overall sequence forms a sub-sequence, where the consecutive base symbols follow one another in decoding and/or reading order. In particular, the overall sequence is designed such that each sub-sequence of t consecutive base symbols read forward is contained only once in the overall sequence and each sub-sequence read backward is not contained in the overall sequence read forward. Preferably, a sub-sequence comprises at least five consecutive base symbols, in particular at least twenty consecutive base symbols, and especially at least thirty base symbols. Furthermore, the sub-sequence preferably comprises fewer than fifty base symbols and in particular fewer than thirty base symbols. In particular, t<g.

In a particularly preferred embodiment of the present invention, the base symbols are designed to encode digits to a number base b. The number base b is preferably the base of a place value system. Preferably, the number base b=2, the base of a binary system, where the digits of the binary system include 0 and 1. Furthermore, it is possible that the number base b=10 and forms the base of a decimal system, where the decimal system includes the digits 0, 1, 2, 3, 4, 5, 6, 7, 8 and 9.

Alternatively, the number base b=16, the base of a hexadecimal system, where the hexadecimal system includes the digits 0, 1, 2, 3, 4, 5, 6, 7, 8, 9, A, B, C, D, E and F. In particular, the number base b can be chosen arbitrarily, where the digits of the number base include the elements 0, 1, . . . b−1. Alternatively and/or additionally, the number base b is the base of an additive number system, such as Roman numerals.

In a particularly preferred embodiment of the present invention, the number base b=2 is chosen. In particular, the chosen number base b=2 forms a binary system. The binary system and/or the number system with the number base b=2 comprises two digits, in particular the digit 0 and the digit 1. Preferably, two different base symbols encode the digits 0 and 1 of the binary system. The two different base symbols are formed by two circles, a first circle with a radius R1 and a second circle with a radius R2. In particular, the radius R1 is chosen smaller than the radius R2. In particular, the ratio of radius R2 to radius R1 is greater than the square root of 2. For example, the radius R2 is chosen to be smaller than half the grid spacing of the code grid, so that two adjacent circles with R2 in the periodic grid do not touch each other. This embodiment is based on the consideration that on the one hand a particularly high information density is achieved, and on the other hand reliable readability is achieved with standard image processing methods such as segmentation using blob analysis.

In a possible embodiment of the present invention, the overall sequence is designed such that a checksum of a sub-sequence is less than half of the maximum possible checksum of a sub-sequence. In particular, the checksum for any sub-sequence taken from the overall sequence is less than half of the maximum possible checksum of a sub-sequence. For example, the checksum of any sub-sequence of length t in a number system with base b is less than t·(b−1)/2.

In a particularly preferred embodiment of the present invention, the two-dimensional code arrangement comprises an inverted overall sequence. The inverted overall sequence preferably represents an inversion of the overall sequence. Preferably, the inverted overall sequence is entered into the Y parcel regions of a plurality of parcels that are adjacent in the Y direction. The entry of the base symbols is carried out in particular according to their order in the inverted overall sequence, preferably in the ascending Y direction of the parcels, within each parcel in the previously defined reading and/or decoding order in the Y parcel regions. The number g is sufficiently large that the Y parcel regions of all adjacent parcels in the Y direction can be completely filled. In particular, the contents of the Y parcel regions of parcels adjacent in the X direction are identical.

In a possible embodiment of the present invention, the base symbol at the k-th position of the inverted overall sequence is the coded digit m(k), where the digit m(k) satisfies the relation with the digit n(k) coded by the base symbol at the k-th position in the overall sequence: m(k)=b−n(k)−1. For example, the inverted overall sequence and the overall sequence for the choice of a binary system with base b=2 form the relation: m(k)=1−n(k).

### Definition of Support Point:

Particularly preferably, the portion includes a support point. The support point is, for example, the intersection point of the optical axis of the camera with the plane in which the code arrangement lies. Preferably, the method is designed to determine the position of the camera in relation to the work area on the basis of the image captured by the sensor unit, such as the X coordinate (rx) and the Y coordinate (ry) of the support point in a coordinate system which is spanned by the work area and/or the base symbols and/or the code arrangement.

Initially, the method only determines the coarse position in the form of the coded X coordinate and the coded Y coordinate as two degrees of freedom. The coarse position alone already provides a reliable and usable position for the coarse positioning of the camera.

By determining the X coordinate and the Y coordinate in the code arrangement as a coarse position, the relative position of the camera with respect to the code arrangement can be inferred. For example, if the coarse position is determined in the immediate vicinity of the support point, the position of the camera can be deduced from the knowledge of the course of the optical axis of the camera. A quasi-exact position of the camera is obtained by the support point being identical to the coded position and the angle of the optical axis to the code arrangement being known. The simplest case is that the optical axis is aligned perpendicular to the code arrangement.

### Definition of Degrees of Freedom:

In a particularly preferred embodiment of the present invention, the method is designed to determine the position and/or the orientation of the working module with respect to the work area in up to six degrees of freedom. The degrees of freedom are in particular:
rx: Location coordinate in the coordinate system of the code arrangement (as coarse position and/or fine position).
ry: Position coordinate in the coordinate system of the code arrangement (as coarse position and/or fine position).

In particular, rx and ry refer to the support point, in particular the point where the optical axis passes through the code arrangement.
rz: Distance from the reference point to the camera along the optical axis.
phiz: Z angle of rotation of the camera around the optical axis.
phix: first pitch angle of the optical axis to the code arrangement, in particular with respect to the first main direction.
phiy: second pitch angle of the optical axis to the code arrangement, in particular with respect to the second main direction.

### Definition of X, Y Coordinate (Rx, Ry):

For example, the six degrees of freedom of the position and/or orientation of the camera to the work area include the coordinates X and Y with respect to the Cartesian coordinate system spanned by the base symbols, in particular in a coordinate system (X_{C}, Y_{C}) of the code arrangement in the plane of the code arrangement.

### Definition of Distance Between the Support Point and the Optical Center of the Camera (Rz):

Furthermore, the 6 degrees of freedom include the distance Z or r_{z} of the camera to the support point along the optical axis, where the distance is e.g., the distance between the support point and e.g., the optical center of the camera objective.

### Definition of Angle of Rotation:

Furthermore, the three independent angles of rotation of the camera are determined in a camera coordinate system. Two of the angles of rotation are specifically defined as intermediate angles between the optical axis and the code arrangement (phix, phiy). The third angle of rotation (phiz) refers to the rotation of the camera around the optical axis.

### Definition of the Coordinate System of the Code Arrangement:

The coordinate system (X_{C}, Y_{C}) of the code arrangement lies in the plane of the code arrangement.

Definition of the Coordinate System of the Image Sensor of the Camera and/or in the Camera Image:

The coordinate system (X_{I}, Y_{I}) of the image sensor lies in the plane of the image sensor or in the camera image.

### Definition of Camera Coordinate System:

The coordinate system (X, Y, Z) of the camera has its origin at the optical center of the camera objective, with the negative Z direction coinciding with the optical axis of the camera.

### Generalization:

While in the present case the origin and orientation of the coordinate systems are specified by way of example, equivalent coordinate systems can also be used.

### Definition of Method:

In some variants of the present invention, the method is characterized in that the X coordinate value and the Y coordinate value are decoded and/or determined on the basis of the camera image captured by the camera. In a possible further development of the method, the orientation of the portion of the code arrangement captured in the image is determined with respect to three coordinate axes. In particular, the orientation of the portion captured in the image is determined with respect to the X axis and the Y axis of the Cartesian coordinate system, which is spanned by the base symbols. Alternatively and/or additionally, the coordinates of the position of the support point in the code arrangement are determined by decoding the portion of the code arrangement contained in the image. In a particularly preferred embodiment of the present invention, in the method the position of the working module relative to the work area is determined in up to six degrees of freedom. In particular, the position of the camera in the work area is determined in three Cartesian coordinates X, Y, Z, where X and Y are the coordinates of the coordinate system spanned by the base symbols and Z is the distance of the work module to the work area. Furthermore, the method determines, for example, the three Euler angles of the camera.

Alternatively and/or additionally, the two-dimensional code arrangement is used in areas outside of automation technology, for example for monitoring movement sequences in nature and the environment, biology and medicine, architecture, consumer electronics and/or sensor technology.

Some General Advantages of the Present Invention are, Depending on the Variant:

A main object of the present invention is to provide a powerful, reliable and cost-effective method for localizing and identifying one or more objects in a work area in up to six degrees of freedom (6D localization=simultaneous position detection in 6 degrees of freedom).

The method processes image data provided by an imaging measurement system, such as a camera. For example, a smartphone can also be used to capture images and ascertain the position using the method according to the present invention, wherein the method is implemented as an algorithm in an application that is executed by the embedded computer of the smartphone or in the cloud.

To determine the position of an object in up to six degrees of freedom, the camera captures a two-dimensional code arrangement associated with the object to be located.

The method according to the present invention offers the following properties depending on the variant:
Up to full 6D position information: Translation(X, Y, Z) and rotation (φ_X, φ_Y, φ_Z)
Absolute position information (not incremental), i.e., a referencing run as with incremental sensors is omitted
Very large measuring range:
in X, Y “almost infinite,” limited only by the code arrangement. Examples: uniquely codable surface using the code described in [B] and point grid 2.5 mm:
   for parcel size 5×5 dots: 2 m×2 m
   for parcel size 7×7 dots: 8 km×8 km
   for parcel size 9×9 dots: 550,000 km x 550,000 km
   in Z: only dimension with boundary. Adaptable to the application via camera resolution, objective and grid spacing of the code arrangement.
   in φ_X, φ_Y: currently+/−60°
   in φ_Z infinite (0°-360°)
High measurement rate, for example 100 Hz-10,000 Hz
Short latency (time from image capture to output of the 6D position measurement value), e.g., 10 ms-100 μs.
High measurement accuracy in all six degrees of freedom: currently 1 μm and 0.01° repeatability (at 3 sigma), with a code grid spacing of 2.5 mm
Maximum reading reliability, even with local disturbances in the image or fluctuations in image brightness
Cost-effective, both the sensor system and the code arrangement
Additional data readable, simultaneously with localization. For example, an ID code integrated into the code arrangement can be read to identify the object.
Scalable in terms of accuracy, measuring range in Z, redundancy and measurement rate by modifying the objective, image sensor resolution, grid spacing of code arrangement, size of the reading field, computing power, etc.
Easy integration into existing systems, for example as a smartphone app

This makes it easy to implement a wide range of automation applications that were previously not feasible or not economically viable, for example:
Precise localization of axes or runners in an axis system or robot system to realize real-time position control in up to six dimensions.
Setting up absolute positioning systems and robots that do not require reference runs
Simplification of positioning systems, since multiple one-dimensional measuring sensors can be replaced by one multi-dimensional measuring sensor.
Visual servoing, e.g., for tracking a robot gripper to a moving target.
Monitoring and tracking of multiple objects in space through cyclic position measurement
Recording and analysis of movement sequences
Vibration analysis of machines in 6 dimensions.
Determining the relative position of two objects. A camera, for example in a hand-held device, captures two objects in one image, each of which is given a point code. The proposed method allows the localization of both objects with respect to the common camera coordinate system. The relative position of the two objects to each other can be ascertained by vectorial subtraction. The position of the camera is eliminated mathematically here, i.e., the method is largely independent of the camera position.
Determination of the relative position of more than two objects, each equipped with cameras and/or code arrangements.
Construction of a localization network, e.g., in a production hall, to localize multiple stationary or moving objects relative to each other or relative to a hall coordinate system. For example, a plurality of autonomous vehicles, each equipped with a camera, locate themselves by detecting a code arrangement attached to the ceiling of the hall.

The code arrangement has a point grid with a plurality of base symbols, wherein a coarse position of the base symbols is encoded in the code arrangement.

The base symbols define a first and a second main direction (independent of the first) along the point grid. Depending on the viewing angle, the two independent main directions in the camera image are aligned perpendicular or obliquely to each other.

A reference point is arranged in the camera image. The reference point is formed as an intersection point of the optical axis with the image sensor and/or with the camera image. The reference point is thus specified by the camera in the coordinate system of the camera and/or in the camera image.

The point grid in the camera image is in particular perspectively distorted, so that although the rows and columns of the point grid are each formed in a straight line, the rows and columns are not arranged perpendicular to one another in the perspective distortion, but at an oblique angle to one another.

The following values are determined as characteristic values from the camera image at the reference point:

A, or the, angle of rotation Phiz—also called the Z angle of rotation—of the camera about the optical axis of the camera is determined.

Furthermore, at least one local grid spacing of the point grid in the camera image is determined. The local grid spacing specifies the distance between two adjacent straight lines of the point grid in the camera image. The point grid in the code arrangement is regular and/or has a regular grid spacing. By capturing the code arrangement with the camera, which leads to the camera image, the grid spacing is imaged with distortion, so that the grid spacing changes across the camera image. The local grid spacing at the reference point is understood as the value of the grid spacing at the reference point.

Furthermore, at least a first and a second local angular divergence of the point grid in the camera image is determined. In principle, the straight lines are arranged parallel to each other in the point grid in the code arrangement. However, by mapping the code arrangement onto the camera image, the point grid is distorted, so that the straight lines each take up a difference angle not equal to 0 between two adjacent straight lines. The local angular divergence of the point grid in the camera image is understood as the difference angle between two adjacent straight lines of the point grid at the reference point. This is a first local angular divergence for the first main direction and a second local angular divergence for the second main direction.

From a physical point of view, the mentioned characteristic values completely describe three degrees of freedom of the camera relative to the code arrangement, namely a distance rz between the code arrangement and the camera at the reference point and/or along the optical axis, as well as two pitch angles phix and phy, which describe an intermediate angle of the optical axis and the plane of the code arrangement in the first and second main direction. The mentioned characteristic values are therefore sufficient to determine the three degrees of freedom mentioned.

A consideration of the present invention is that the above-mentioned characteristic values can be easily determined from the camera image. In addition to a determination “by hand” of the characteristic values in the camera image, it is also possible to derive them using digital image processing methods. When the characteristic values are known, the three degrees of freedom mentioned can be deduced.

Through the selection of the above-mentioned characteristic values, a new method for determining the mentioned degrees of freedom is thus proposed which is characterized by the use of only a few characteristic values for determining the degrees of freedom. This makes it possible to design the method in a computationally efficient and highly accurate manner.

In a preferred embodiment of the present invention, the above-mentioned characteristic values are used in an imaging model which describes the optical imaging of the code arrangement onto the image sensor, taking into account the position and orientation of the camera relative to the code arrangement.

The model describes the physical and thus analytical relationship between the above-mentioned characteristic values as input values and the three above-mentioned degrees of freedom as output values. This relationship thus leads to the determination of the three degrees of freedom.

In one possible example embodiment of the present invention, for the three degrees of freedom three equations are determined which form a system of equations. It is to be emphasized that the three equations are possible representations of the analytical relationships between the characteristic values and the three degrees of freedom; other mathematical or analytical representations are possible. However, the physical relationship can be presented particularly simply and compactly using the three equations and/or the system of equations.

The equation for determining the first pitch angle phix is in particular a function of the first local angular divergence dalphac0, the distance rz between the code arrangement and the camera, and the second pitch angle phiy.

In particular, the first pitch angle is determined using the following equation:

$$tan {φ}_{X} = \frac{- d {α}_{C 0} \cdot {r}_{Z}}{{c}_{grid} \cdot {cos}^{2} {φ}_{Y}}$$

where c_{grid}: Grid spacing of the point grid in [m]

The equation for determining the second pitch angle phiy is in particular a function of the second local angular divergence dalphac1, the distance rz between the code arrangement and the camera, and the first pitch angle phix.

In particular, the second pitch angle is determined using the following equation:

$$tan {φ}_{Y} = \frac{- d {α}_{C 1} \cdot {r}_{Z}}{{c}_{g r i d} \cdot cos {φ}_{X}}$$

In particular, the equation for the distance rz between the code arrangement and the camera is a function as follows:

| | | |
|---|---|---|
| Alt. 1: rot_status = 0 | ${r}_{Z 00} = \frac{b \cdot {c}_{grid} \cdot {cos φ}_{Y}}{\begin{matrix}{g}_{C 0} \cdot ( {cosφ}_{Z} - \\ {tanφ}_{X} {sinφ}_{Y} {sinφ}_{Z} )\end{matrix}}$ | ${r}_{Z 10} = \frac{b \cdot {c}_{grid} \cdot {cos φ}_{Y}}{{g}_{C 1} \cdot {cosφ}_{Z}}$ |
| Alt. 2 rot_status = 1 | ${r}_{Z 01} = \frac{b \cdot {c}_{grid} \cdot {cos φ}_{Y}}{\begin{matrix}{g}_{C 0} \cdot ( - {sinφ}_{Z} - \\ {tanφ}_{X} {sinφ}_{Y} {cosφ}_{Z} )\end{matrix}}$ | ${r}_{Z 11} = \frac{b \cdot {c}_{grid} \cdot {cos φ}_{Y}}{{g}_{C 1} \cdot {sinφ}_{Z}}$ |

with
b: Image distance of the camera in [m]
g_{c0}, g_{c1}: local grid spacing of the point grid in the camera image, in [m]

The columns refer to two independent variants and the rows refer to two alternatives depending on the definition and/or convention of the angle of rotation Phiz.

Alternatively or additionally, according to an example embodiment of the present invention, the distance between the code arrangement and the camera is determined as the average of the variants and/or functions using the following equation:

$${r}_{Z} = \frac{{r}_{Z 0 k} + {r}_{Z 1 k}}{2}$$

In principle, the system of equations can be solved analytically. In a preferred development of the present invention, the system of equations comprising the three equations is solved iteratively. Starting values are first specified and then the degrees of freedom are determined in iterative steps in an optimization routine.

Preferably, according to an example embodiment of the present invention, an in particular two-dimensional base symbol matrix is ascertained from the camera image, wherein each grid point of the code arrangement is assigned an entry in the base symbol matrix and wherein the center point position of the base symbols in the camera image is entered in the base symbol matrix. Thus, an entry in the base symbol matrix refers to the position of the base symbol in the assigned grid point, in particular in a coordinate system of the image sensor and/or in a coordinate system of the camera image.

The point grid in the camera image is in particular perspectively distorted, so that although the rows and columns of the point grid are each formed in a straight line, the rows and columns are generally arranged at an oblique angle to one another in the perspective distortion.

In addition, optical distortion may occur, which can optionally be compensated for by rectification.

According to an example embodiment of the present invention, a first linear function in a coordinate system of the camera image for a first straight line with a first function argument is determined from the data of the base symbol matrix. The first straight line is always parallel to the first main direction of the point grid, independent of the first function argument, if the first straight line is mentally transposed into the coordinate system of the code arrangement. By changing the first function argument, the first straight line is shifted parallel in the second main direction in the coordinate system of the code arrangement. Thus, by changing the first function argument, the straight line can be placed for example on a row of the point grid, both in the coordinate system of the code arrangement and in the coordinate system of the camera image.

More generally, according to an example embodiment of the present invention, this can be realized as follows:

### Initial Situation:

a) The center points of the base symbols form a two-dimensional point grid with regularly arranged straight-line rows and columns in the code plane
b) The camera images the code plane on the image sensor with a distorted perspective. In the camera image, the rows generally appear as fanned-out lines that have a common vanishing point. The same applies to the columns.
c) Due to distortion of the objective, the rows and columns appear as curved lines in the camera image.

According to an example embodiment of the present invention, method steps in the camera coordinate system include:
a) Rectification mathematically eliminates the distortion of the objective, transforming the curved lines into straight lines.
b) By linear interpolation, straight lines are adapted to the rows and numbered according to their sequence using an integer index as a function argument. They form a first straight line bunch. The same procedure is followed with the columns; they form a second straight line bunch.
c) Every straight line is described by a linear angle and an axis intercept value. The linear angles of a bunch form a sequence of numbers that is approximated by quadratic interpolation. The integer line index serves as the function argument. The polynomial has three interpolation parameters. The axis intercept value is used in a similar way, resulting in three further interpolation parameters. Each straight line bunch is therefore completely and compactly described by six interpolation parameters.
d) By inserting rational function values into the interpolation function, straight lines that lie between two rows or columns can also be calculated.

Alternatively or additionally, according to an example embodiment of the present invention, a second linear function is determined on the basis of the base symbol matrix in a coordinate system of the camera image for a second straight line with a second function argument. The second line is always parallel to the second main direction of the point grid, independent of the second function argument, if the second line is transposed into the coordinate system of the code arrangement. By changing the second function argument, the second straight line is shifted parallel in the first main direction in the coordinate system of the code arrangement. Thus, by changing the second function argument, the straight line can be placed for example on a row of the point grid, both in the coordinate system of the code arrangement and in the coordinate system of the camera image.

It should be noted that the terms row and column are in particular for naming purposes only and do not imply a specific orientation of the point grid.

The local angular divergence and/or the local grid spacing can be determined from the linear functions. In particular, these are determined by determining the adjacent straight lines to the reference point and deriving the characteristic values from the adjacent straight lines.

According to an example embodiment of the present invention, a further consideration is that the amount of data should be reduced on the path from the camera image to the at least one degree of freedom in order to enable a faster and/or more efficient calculation of the at least one degree of freedom. While for example the camera image with an image size of 200×200 pixels still has 40,000 values, the base symbol matrix is already reduced to the position and accordingly has only 225 values for the positions in a portion of the camera image, e.g., with an edge length of the point grid of 15 base symbols. By deriving the at least one linear function, the amount of data is reduced to the parameters of the linear function.

It has been shown that 6 parameters, optionally plus one datum, per linear function are sufficient to the essential information content of the base symbol matrix or the camera image onto the path to the at least one degree of freedom, so that the amount of data in the example is reduced from 225 entries to 12 or 14 entries. This significantly reduces the effort required to calculate the at least one degree of freedom.

A further advantage of the implementation of the present invention is that the rows and columns of the base symbol matrix in the code arrangement are arranged parallel to each other and regularly spaced, so that by deriving the linear function in the camera image, a kind of averaging is also carried out over the base symbol matrix, wherein the linear functions describe an averaged item of information of the base symbol matrix. The linear functions condense the information while simultaneously improving the information content.

Thus, the method according to the present invention allows a computationally efficient implementation of the method for ascertaining at least one degree of freedom of the camera relative to the code arrangement from the camera image of the camera. From an application point of view, the ascertaining can be carried out for example on a microcontroller which can determine at least one degree of freedom at least 100 times per second. In this way, it is possible to carry out real-time applications with the method, for example in manufacturing.

In a preferred development of the present invention, the first linear function is determined on the basis of at least two rows, preferably more than two rows, in particular on the basis of all rows of the base symbol matrix. Alternatively or additionally, the second linear function is determined on the basis of at least two columns, preferably more than two columns, and in particular all columns of the base symbol matrix. This development underlines the fact that the linear function carries averaged and/or condensed information about a plurality of rows or columns.

In a preferred specific embodiment of the present invention, a first best-fit line is formed for each row along the first main directions. The first linear function is formed on the basis of a plurality of the first best-fit lines. By forming a first best-fit line through a row, this first best-fit line can be adapted to the course of the row, so that the first best-fit line already forms an averaged and/or condensed item of information about the underlying row. The first linear function is formed on the basis of a plurality of the first best-fit lines, where this is done by a second averaging or condensing, so that the first linear function is formed by a double averaging of the original information.

Alternatively or additionally, according to an example embodiment of the present invention, a second best-fit line is formed for each column along the second main directions. The second linear function is formed on the basis of a plurality of the second best-fit lines. By forming a second best-fit line through a column, this second best-fit line can be adapted to the course of the column, so that the second best-fit line already forms an averaged and/or condensed item of information about the underlying column. The second linear function is formed on the basis of a plurality of the second best-fit lines, where this is done by a second averaging or condensing, so that the second linear function is formed by a double averaging of the original information.

In a preferred implementation of the present invention, the first function argument is configured as an integer first count value of the rows and/or the second function argument is configured as an integer second count value of the columns. For an integer first count value in the first linear function, the first straight line thus corresponds to a first best-fit line. Similarly, if the second function argument in the second linear function is an integer second count value, the second straight line corresponds to one of the columns of the base symbol matrix. However, the first straight line and/or the second straight line is not exactly the first best-fit line or the second best-fit line, since the linear function has undergone the second averaging/condensing, so that it is a corrected first best-fit line or corrected second best-fit line.

In a preferred implementation of the present invention, the best-fit lines are described by a linear angle as an intersection angle and at least one axis intersection point with a, or the, coordinate system of the image sensor and/or of the camera image. For the best-fit line, the linear angle and the axis intersection point of at least or exactly one coordinate axis of the coordinate system are sufficient to uniquely determine the best-fit line in the coordinate system.

Through this implementation, the positions of the best-fit lines in the point grid of the corresponding row or column are reduced to two values.

In a preferred development of the present invention, the linear function is formed by a combination of a linear angle function of the linear angle depending on the function argument of the linear function and an axis intersection point function of the axis intersection point depending on the function argument of the linear function. The linear function is therefore also determined by the linear angle and at least one axis intersection point.

According to an example embodiment of the present invention, it is preferred that the linear angle function is formed as a second degree polynomial and/or the axis intersection point function is formed as a second degree polynomial, wherein the polynomials have the function argument of the corresponding linear function as the function argument. This ensures that the linear angle and/or the axis intersection point can be determined depending on the function argument. By choosing a second-degree polynomial, the approximation can be carried out particularly easily, so that the computational efficiency is further increased.

In a preferred specific embodiment of the present invention, depending on the linear angle of the linear function with the coordinate system, that axis intersection point of the coordinate axis of the coordinate system is selected which leads to a smaller intermediate angle to a perpendicular to the corresponding coordinate axis. Furthermore, a datum which encodes the selected coordinate axis is assigned to the linear function. It is a consideration that to describe the straight line only the axis intersection point of a single coordinate axis is necessary, but not the axis intersection points with both coordinate axes. In order to achieve the greatest possible informational significance, that axis intersection point is chosen whose associated crossing angle is more perpendicular to the crossed coordinate axis.

In a development of the present invention, the coarse position of at least one of the base symbols in the code arrangement is determined on the basis of the base symbols of the base symbol matrix or a subset thereof. In particular, a reading field is defined in the camera image and/or planar point grid and a corresponding base symbol matrix is formed, wherein each point in the reading field is assigned an entry in the base symbol matrix, wherein the position and the in particular normalized area or the datum of the base symbols are entered in the base symbol matrix, wherein the coarse position of the coordinate system of the point grid and/or of at least one base symbol in the code arrangement is ascertained as the two degrees of freedom on the basis of the base symbol matrix.

Preferably, according to an example embodiment of the present invention, a first axis intersection point function is formed in the coordinate system of the camera image from a first straight line. The first straight line is aligned parallel to the first main direction of the point grid in the coordinate system of the code arrangement. The axis intersection point function has a first function argument, wherein by changing the first function argument the first straight line in the coordinate system of the code arrangement is shifted parallel in the second main direction. The first axis intersection point function defines, depending on the first function argument, a first axis intersection point along a first axis of the coordinate system of the camera image, wherein the first axis passes through the reference point. By shifting the first straight line by changing the first function argument in the coordinate system of the code arrangement, the first straight line is thus shifted, with perspective distortion, in the coordinate system of the camera and/or the camera image in such a way that the axis intersection point moves along the first axis.

Furthermore, according to an example embodiment of the present invention, a second axis intersection point function in the coordinate system of the camera image is preferably formed by a second straight line. The second straight line is aligned parallel to the second main direction of the point grid in the coordinate system of the code arrangement. The axis intersection point function has a second function argument, wherein by changing the second function argument the second straight line in the coordinate system of the code arrangement is shifted parallel in the second main direction. The second axis intersection point function defines, depending on the second function argument, a second axis intersection point along a second axis of the coordinate system of the camera image, wherein the second axis passes through the reference point. By shifting the second straight line by changing the second function argument in the coordinate system of the code arrangement, the second straight line is thus shifted, with perspective distortion, in the coordinate system of the camera and/or the camera image in such a way that the axis intersection point moves along the second axis.

Based on the axis intersection point functions, the first and second function arguments are determined such that the reference point forms the first and the second axis intersection point. Figuratively speaking, the first function argument is varied until the first straight line in the coordinate system of the camera and/or of the camera image passes through the reference point and/or the first axis intersection point lies on the reference point. In the same way, the second function argument is varied until the second straight line in the coordinate system of the camera and/or the camera image passes through the reference point and/or the second axis intersection point lies on the reference point.

Subsequently, based on the first and the second function argument and the coarse position, the fine position of the reference point in the coordinate system of the code arrangement in the plane of the code arrangement is determined as a further degree of freedom. In theory, the coarse position of the base symbol in the coordinate system of the code arrangement is first determined and then a shift of the base symbol to the reference point is determined on the basis of the function arguments.

The method of the present invention has the advantage that the coarse position of the base symbol can be determined by decoding the code arrangement. Subsequently, the shift up to the reference point is calculated on the basis of the axis intersection point functions, wherein by using the axis intersection point functions, the calculation can be carried out with few calculation values and thus in a computationally efficient manner. This has the advantage that the method can be carried out in real-time applications even with digital data processing devices, in particular microcontrollers, with low computing power.

In a preferred embodiment of the present invention, the first function argument is a count value of the rows and/or the second function argument is a count value of the columns in the point grid. Figuratively speaking, the position of the base symbol, whose coarse position is known, is shifted to the reference point by whole steps or partial steps in the grid spacing of the point grid.

As discussed above, the reference point is particularly preferably formed as an intersection point of the optical axis of the camera with the image sensor. The reference point is thus defined as a constructive position in the coordinate system of the camera and/or the camera image. However, it is not absolutely necessary for the reference point and/or the intersection point to be located exactly in the center of the camera image and/or on the image sensor of the camera. Rather, the position of the reference point can be defined via calibration.

In one possible embodiment of the present invention, the axis intersection point function is designed as a linear function for describing the straight lines, in particular as described above. In this case, the axis intercept point function comprises a complete mathematical description of the straight line depending on the corresponding function arguments.

Alternatively, according to an example embodiment of the present invention, a linear function is used, in particular as described above, which is formed by a combination of a linear angle function of the linear angle as the angle of intersection of the straight line with one of the axes of the coordinate system of the camera image depending on the function argument and the axis intersection point function. The straight line is thus completely described by an axis intersection point and by a linear angle. This division has the advantage that to determine the fine position only the axis intersection point function needs to be determined and/or evaluated, without any information about the linear angle. This design further increases the efficiency of the method.

Based on the function arguments and a known grid spacing of the point grid, the fine position can then be determined.

Figuratively speaking, the fine position is determined in such a way that, for example, starting from the position of the base symbol with the known coarse position, a fraction of a grid spacing must be traveled in the first main direction and a fraction of the grid spacing must be traveled in the second main direction in order to reach the reference point in the coordinate system of the code arrangement. This representation is particularly computationally efficient.

According to an example embodiment of the present invention, it is preferably provided that the first and/or the second function argument of the linear function is determined such that the first and/or the second straight line intersect(s) the reference point. For example, by varying the function argument, the first and second straight line are shifted so that they intersect the reference point.

An angle of rotation Phiz of the camera about the optical axis is derived as a degree of freedom of the camera relative to the code arrangement on the basis of the first and/or second straight lines that intersect the reference point. The derivation is possible because the straight line functions are defined in the camera image. Thus, it is possible to determine the angle of rotation Phiz as a linear angle in the coordinate system of the camera and/or of the camera image. Theoretical considerations have shown that the linear angle in the coordinate system of the camera and/or of the camera image corresponds to the angle of rotation Phiz of the camera about the pivot axis, without the need to carry out a transformation of the coordinate systems from the coordinate system of the camera and/or of the camera image to the coordinate system of the code arrangement. Thus, it is possible to determine the angle of rotation Phiz in a simple way based on at least one linear function. This development thus indicates a way in which the angle of rotation Phiz can be determined with great accuracy and without large computational effort. It is to be emphasized that the determination is particularly easy if the intersection point of the optical axis of the camera with the camera image or with the image sensor is chosen as the reference point. In this special configuration, the angle of rotation Phiz can be derived particularly easily. The method thus allows a simple and at the same time highly accurate determination of the angle of rotation Phiz from the camera image, which is then available as a degree of freedom of the camera relative to the code arrangement.

In a preferred embodiment of the present invention, the base symbol matrix is ascertained from the camera image, wherein the position of the base symbols in the camera image is entered in the base symbol matrix. Thus, a position in the base symbol matrix refers to the position of the base symbol in the point grid, in particular in a coordinate system of the image sensor and/or in a coordinate system of the camera image. The first and/or the second linear function is preferably determined on the basis of the base symbol matrix.

According to an example embodiment of the present invention, particularly preferably, a linear function is used which is formed by a combination of a linear angle function of the linear angle as the angle of intersection of the straight line with one of the axes of the coordinate system of the camera image depending on the function argument and an axis intersection point function. Depending on the first function argument, the axis intersection point function defines an axis intersection point along an axis of the coordinate system of the camera image, where the axis passes through the reference point. By shifting the straight line by changing the first function argument in the coordinate system of the code arrangement, the straight line is thus shifted, with perspective distortion, in the coordinate system of the camera and/or the camera image in such a way that the axis intersection point moves along the axis. The one linear function or combination of linear angle function and axis intersection point function is assigned to the first main direction and the other linear function or combination of linear angle function is assigned to the second main direction. The advantage of the division is that the function argument can be determined via the axis intersection point function and then the angle of rotation Phiz can be read out from the linear angle function on the basis of the determined function argument.

In a preferred development of the present invention, a first value for the angle of rotation Phiz is determined from the first linear function and a second value for the angle of rotation Phiz is determined from the second linear function and subsequently the angle of rotation Phiz is determined as the mean value of the two values. Because the angle of rotation Phiz can be determined independently from both linear functions, two independent values are obtained, which can then be averaged to ascertain the angle of rotation Phiz in order to improve the measurement accuracy. Alternatively, a plausibility check can be carried out and one of the two values can be rejected if it is not plausible or valid.

According to an example embodiment of the present invention, preferably, as part of the method, a starting field is determined. The starting field has at least three base symbols, preferably adjacent to each other, which are arranged at an angle to each other. The connecting lines between the base symbols of the starting field define two independent main directions along the point grid in the camera image. In the event that the starting field has exactly three base symbols, these are arranged for example at an angle to each other. They define a coordinate system of the planar point grid, with one of the at least three base symbols forming the origin of the coordinate system. In a preferred development of the present invention, the starting field has nine base symbols which are arranged in a square and/or rectangular configuration. In particular, the starting field has an edge length with three base symbols. The base symbols of the starting field are valid base symbols. Valid base symbols are understood to mean, in particular, the base symbols which are, optionally, defined as valid within the framework of the method or classified as valid base symbols based on image features and/or set as valid by finding the base symbols and successfully processing the base symbols with a usable processing result. Image structures that are not classified as valid base symbols are interpreted as image noise and are excluded from further processing.

In the method of the present invention, in a search step, starting from at least one valid base symbol, additional in particular valid base symbols are searched for along the main directions.

If the search is successful, in particular if additional base symbols are found, the additional base symbols are marked as valid base symbols.

It is intended that the search step is carried out several times. In the event that additional new base symbols are found as valid base symbols in a search step, the search step is carried out, optionally, from the base symbol of the starting field or from the newly found valid base symbols. In this way, the point grid is gradually supplemented with further valid base symbols, starting from the starting field with valid base symbols. The search step is repeated until a sufficient number of valid base symbols have been found, in particular so that decoding can take place.

According to an example embodiment of the present invention, based on the valid base symbols or a selected subset thereof, in particular by decoding the valid base symbols, the coarse position of at least one of the base symbols in the code arrangement is determined as two degrees of freedom of the camera relative to the code arrangement.

In particular, the valid base symbols or a subset thereof are decoded, wherein at least one degree of freedom of the camera relative to the code arrangement is ascertained from the decoded coarse position and the optionally additional coarse orientation of the coordinate system of the point grid in the camera image.

It is a further consideration here that the base symbols in the code arrangement and/or in the camera image can be searched for and found, for example using areal functions of image processing. However, finding base symbols, for example using blob analysis or pattern matching, requires frequent access to the pixels of the camera image and thus leads to complex image processing.

By searching exclusively in the main directions starting from the search field, which defines the two main directions of the point grid and thus the point grid, in particular the coordinate system of the point grid, in the camera image, the a priori knowledge about the structure of the point grid can be used, so that the search is not area-oriented, but line-oriented along the main directions. From a practical point of view, it is sufficient to start from a valid base symbol and search for another base symbol along a line in the main direction. It is obvious that by reducing an area search to a line search, the number of pixel accesses and/or the effort for image processing is significantly reduced. Thus, the method according to the present invention enables a very efficient implementation of the method.

In a preferred development of the present invention, the center point position, in particular the center of gravity position of the base symbol in the camera image, is determined for each of the base symbols. This allows a large number of intersection points to be ascertained in the point grid on the basis of the valid base symbols.

According to an example embodiment of the present invention, it is provided that the search step is carried out starting from the center point position of each valid base symbol, in particular a line-oriented search in a predetermined search direction, in particular along one of the main directions. While finding a base symbol initially allows only an approximate determination of the position of the base symbol in the point grid and/or camera image, detecting the center point position ascertains the exact position in the point grid and/or camera image and thus makes the point grid more concrete. It is advantageous that the in particular line-oriented search step is carried out from the center point position of the base symbol, as this prevents accidental missing of adjacent base symbols.

In a preferred development of the present invention, two connection vectors are determined in the two independent main directions along the point grid in the camera image on the basis of the starting field and/or on the basis of further valid base symbols. By determining the connection vectors, the position of the nearest and/or adjacent base symbol can be estimated by extrapolation starting from the known valid base symbol within the framework of a linear combination of the connection vectors.

Particularly preferably, according to an example the determination of the center point position of a base symbol is carried out in such a way that a starting point in the base symbols is shifted over a plurality of intermediate steps to a center point position along the main directions until the position in which the center point position is arranged centrally in the base symbol in the main directions is found as the center point position. Because the initial position is shifted to the center point position in such a way that it always lies centrally in the main directions, it is only necessary to search for the boundary of the base symbol in the main directions for each shift step and then shift the initial position to the center point between the boundaries.

In the example of a circular base symbol, starting from an initial position within the base symbol, the boundary of the base symbol is searched for by a linear search in a first main direction of the camera image, and then the boundary of the base symbol is searched for in the negative first main direction. Averaging the boundaries leads to a more accurate position estimate. This step is repeated analogously for the second main direction, then again for the first main direction.

In this way, the shift from the initial position to the center point position is performed computationally efficiently through a sequence of line evaluations along the main directions.

In a subsequent step, the area of the base symbols in the camera image is determined, wherein the area forms a datum of the coding of the code arrangement. In particular, the area is used to classify the base symbol.

For example, in the binary system the datum can be a 0 or a 1, where the base symbols are, for example, circular areas of different sizes. For the case in which the center point position and the extent of the base symbol in the main directions due to the shift steps are known, the area of the base symbol can be easily determined using these values. Thus, the center point position in the point grid is first determined in a very computationally efficient manner, followed by the area of the base symbol.

The area of the base symbol in the camera image is strongly influenced by perspective distortion. For example, the area decreases with increasing distance of the camera from the base symbol and with increasing tilt angle of the camera (elliptical distortion). These influences can lead to incorrect classification, for example, if similar base symbols appear in a camera image with very different distances to the camera. Therefore, the normalized area of the base symbol is preferably used to classify the base symbol.

According to an example embodiment of the present invention, to calculate the normalized area, a reference area is ascertained that is subject to approximately the same perspective distortions as the base symbol. As the reference area, a parallelogram is used that is spanned by the two vectors from the grid position of the base symbol to the grid positions adjacent in the main axis direction. The reference area is the magnitude of the cross product of both vectors.

The normalized area of the base symbol is calculated in particular as the quotient of the area of the base symbol and the reference area.

In a preferred embodiment of the present invention, a reading field is defined in the camera image and/or in the planar point grid and a corresponding two-dimensional base symbol matrix, in particular a dot matrix, is formed, wherein each point in the reading field is assigned an entry in the base symbol matrix and wherein the position and the area and/or the datum of the base symbols are entered in the base symbol matrix. From the data in the base symbol matrix, the coarse position and optionally also the coarse orientation of the coordinate system of the point grid can be decoded and/or the coarse position of at least one base symbol in the code arrangement can be ascertained as the two degrees of freedom.

In a preferred development of the present invention, at least one starting position is defined in a preliminary step for creating the starting field. The starting position is determined arbitrarily. Preferably, the starting position is located near or adjacent to the support point. In the case in which the starting position happens to be within a base symbol, the starting position is taken as the initial position for a starting base symbol. In the case in which the starting position is outside a base symbol, an adjacent base symbol is searched for as the starting base symbol along search beams, starting from the starting position. Thus, no computationally intensive area-oriented image processing is carried out in the preliminary step either; rather, starting from the starting position, a base symbol is searched for only along the search beams. The boundary of the base symbol can be detected for example by a change in contrast along the search direction in the camera image. It is possible that at least or exactly 8 or 16 search beams are used in the process which begin in the starting position and are distributed in regular angular steps over 360°. A minimum radius for the search beams can be defined from which an additional base symbol is searched for. Optionally, a maximum search radius can be defined, wherein if the maximum search radius is reached without finding an adjacent base symbol, the starting position is discarded and an alternative starting position is selected.

According to an example embodiment of the present invention, in a subsequent step, starting from the position of the starting base symbol, an adjacent base symbol is searched for as the first auxiliary starting base symbol along further search beams. The search from the first auxiliary starting base symbol can be performed with the same distribution of search beams as previously described.

In a subsequent step, a second auxiliary starting base symbol is searched for starting from the starting base symbol and the first auxiliary starting base symbol in a direction which is at an angle to the connection (and/or along a first main direction) between the starting base symbol and the first auxiliary starting base symbol. However, here fewer search beams can be used than before, and they are in particular distributed over a smaller angle range, so that the search is accelerated. This takes advantage of the fact that the first three base symbols are supposed to be arranged at an angle to each other, so that the direction in which the second auxiliary starting base symbol is searched for is known a priori. For example, only one, two or three to six search beams are used, which are distributed around a main search direction that is oriented perpendicular to the connection between the starting base symbol and the first auxiliary starting base symbol.

For completion, starting from the starting base symbol, all base symbols of the starting base symbol, in particular those immediately adjacent in the main axis direction or diagonal direction of the point grid, are searched for on the basis of the connection between the starting base symbol and the first auxiliary starting base symbol and the connection between the starting base symbol and the second auxiliary starting base symbol, by linear combination of the connections. In particular, the connection vectors and/or main directions can be derived from the first three found base symbols. These span a two-dimensional coordinate system of the point grid. To improve the method, the center point positions can be determined in order to define the connection vectors as accurately as possible. The result is then a starting field with 3×3 valid base symbols.

According to an example embodiment of the present invention, in the search step, adjacent base symbols are searched for starting from the starting field and/or from the further valid base symbols that were found in an earlier search step. The method preferentially searches for base symbols at grid points that have at least two valid neighbors in the main directions or in the diagonal directions. All neighbors of a grid point provide independent position estimates through extrapolation, which, by averaging, lead to a more accurate position estimate of the grid point.

The requirement that only grid points and/or those with at least two valid base symbols as neighbors are searched also promotes a planar expansion of the detected region and avoids linear expansion in the form of lances, dendrites or tips. The areal expansion is more robust and more tolerant to disturbances in the image than the linear expansion. Based on the valid base symbols, the base symbol matrix, in particular of the reading field, will be ascertained.

In particular, the method of the present invention can provide that, firstly, a camera image is captured by the camera, subsequently at least one degree of freedom of the camera relative to the code arrangement is determined, and subsequently for example an actuator of the automation assembly is controlled. For example, the at least one degree of freedom can be output on an optical output device, such as a display. The at least one degree of freedom can be used for position control and/or regulation of the actuator of the automation assembly by using it as an actual value. A robot with the sensor unit of the automation assembly can, for example, determine its absolute position relative to the code arrangement and output this as actual information or move to a predeterminable further position, wherein the robot continues to orient itself to the code arrangement with regard to its actual position.

The present invention further relates to a control unit and/or an automation assembly having the control unit, which is designed to carry out the method as described above. Optionally, the control unit comprises the camera and/or is connected thereto for data exchange.

The present invention further relates to a computer program which is designed to carry out the method described above when the computer program is executed on a digital data processing device and/or on the control unit.

The present invention further relates to a machine-readable storage medium having the computer program.

Further features, advantages and effects of the present invention will be apparent from the following description of preferred exemplary embodiments and the figures.

### BRIEF DESCRIPTION OF THE DRAWINGS

FIG. 1 is a flow chart of the overall method with an exemplary embodiment of the method according to the present invention.

FIG. 2 is a schematic representation of the optical model in 3D, according to an example embodiment of the present invention.

FIG. 3 is a schematic representation of the optical model in 2D, according to an example embodiment of the present invention.

FIG. 4 is a schematic representation of the optical model in 2D.

FIG. 5, 6, 7 show a schematic illustration of the coordinate systems.

FIG. 8 is a schematic illustration of the coordinate system for the imaging model.

FIG. 9 shows the imaging model in FIG. 8 with tilted code plane;

FIG. 10 shows is an illustration of the code arrangement, according to an example embodiment of the present invention.

FIG. 11 is a further illustration of the code arrangement.

FIG. 12 shows a point grid of a code arrangement with two exemplary reading fields drawn in.

FIG. 13 shows different angular positions of the reading field.

FIG. 14 shows an example of a reading field.

FIG. 15 shows an exemplary structure of a parcel in the code arrangement, according to the present invention.

FIG. 16 shows further exemplary structures of a parcel in the code arrangement, according to the present invention.

FIG. 17 shows a flow chart of a validity test, according to the present invention.

FIG. 18 shows details of the validity test, according to the present invention.

FIG. 19 shows an example of a camera image with an identified starting base and the reading field, according to the present invention.

FIG. 20 shows an example of a base symbol matrix with the area datum entered, according to an example embodiment of the present invention.

FIG. 21 shows a flow chart for determining the starting base, according to the present invention.

FIG. 22 shows multiple predefined starting positions in the field of view of the camera, according to the present invention.

FIG. 23 shows an illustration of the method for determining the starting base, according to an example embodiment of the present invention.

FIG. 24 shows an illustration of the method for determining the starting base, according to an example embodiment of the present invention.

FIG. 25 shows a flow chart of the Center_Pos function, according to an example embodiment of the present invention.

FIG. 26 shows an illustration of the Center_Pos function, according to an example embodiment of the present invention (steps a-h are shown).

FIGS. 27A and 27B show an illustration of the Nearest dot function, according to an example embodiment of the present invention.

FIG. 28 shows a flow chart of the sequence for detecting all dots/base symbols in the reading field, according to an example embodiment of the present invention.

FIG. 29A-29D show an illustration of the sequence for detecting all dots/base symbols in the reading field, according to an example embodiment of the present invention.

FIG. 30 shows an illustration of the detection of base symbols in a distorted grid, according to an example embodiment of the present invention.

FIG. 31 shows an illustration of the rectification.

FIG. 32 shows a flow chart for classifying base symbols.

FIG. 33 shows a flow chart for determining the coarse position, according to an example embodiment of the present invention.

FIGS. 34A and 34B show a base symbol matrix with entered datum and with reading tracks, according to an example embodiment of the present invention.

FIG. 35 shows an illustration of the decoding of the coarse position, according to an example embodiment of the present invention.

FIG. 36 shows an illustration of the best-fit lines for the linear function, according to an example embodiment of the present invention.

FIG. 37 shows an illustration of the linear angle.

FIG. 38A-38C show an illustration of the best-fit lines and the linear function, according to an example embodiment of the present invention.

FIG. 39 shows an illustration of the determination of the fine position and the angle of rotation phiz (Z angle of rotation), according to an example embodiment of the present invention.

FIG. 40 shows a flow chart for determining the camera distance and the pitch angle, according to an example embodiment of the present invention.

### DETAILED DESCRIPTION OF EXAMPLE EMBODIMENTS

The present invention provides a method as an implementation of an algorithm for precisely determining the absolute 6D position of a camera 1 with respect to a planar code arrangement 2 captured by the camera 1, the algorithm receiving a camera image 3 as input information.

The code arrangement 2 serves simultaneously as an analog and digital scale in two dimensions, X and Y. It consists of symbols arranged in a regular grid. Preferably, it is a binary code with two symbols arranged in a square grid: a small round dot for a digital 0 and a large dot for a 1. The dot type contains the digital information, while the dot center point contains the analog information.

The camera 1 captures a portion of the code arrangement 2 and transmits the camera image 3 to a computer or any data processing device. The algorithm selects a reading field in the camera image 3 with the minimum size of a code cell (e.g., 7×7 dots) and calculates from this the position of the camera 1 with respect to the code arrangement 2 in six dimensions. To do this, the method uses both the digitally coded position information and the precisely measured center point positions of all dots in the measuring field or reading field. These form a grid that is distorted by the camera perspective and the distortion of the objective.

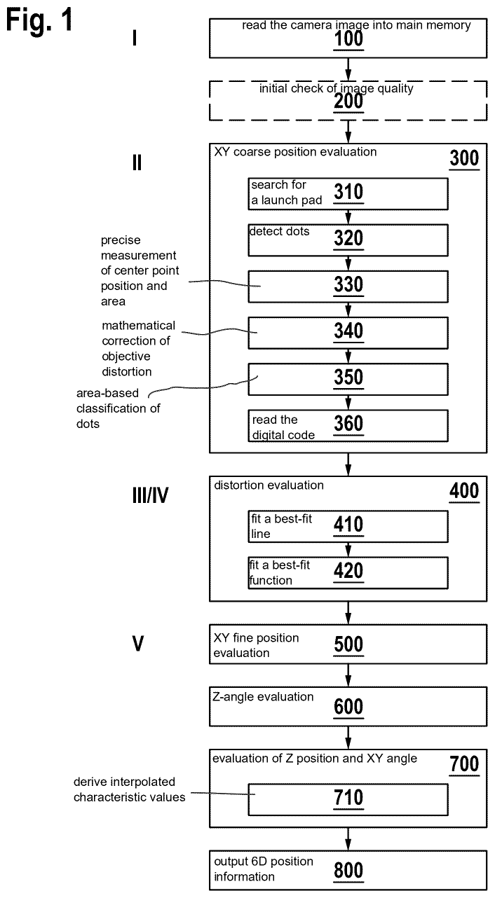

The method for position detection comprises the following steps (see FIG. 1):

Step 100: Reading the camera image 3 into the main memory of the computer.

Step 200: Optional: initial check of the image quality using characteristic data such as brightness and contrast.

Step 300: XY coarse position evaluation and optional z coarse angle evaluation

Step 310: Search for a launch pad of 3×3 dots in the reading field

Step 320: Detection of the dots in a reading field in the camera image

Step 330: Precise measurement of the center point position and area of the dots

Step 340: Optional: mathematical correction of objective distortion by rectifying the dot positions. This converts the lines of the dot grid, which are curved in the camera image 3, into straight lines.

Step 350: Area-based classification of the dots, assignment to the binary digits 0 and 1

Step 360: Reading the digital code in the X and Y axes, determining the absolute coarse position in X, Y and optionally the φ_{Z} direction as z-coarse angle evaluation.

Step 400: Distortion evaluation

Step 410: Fitting a best-fit line (beam) to each row and column of the dot grid of the reading field

Step 420: Fitting a best-fit function to a first straight line bunch by interpolating all straight lines in the rows and a second best-fit function by interpolating all straight lines in the columns of the code grid. Each straight line bunch is completely described by 6 interpolation parameters (bunch data). Using the interpolation function, interpolated straight lines can also be calculated that lie between two measured lines.

Calculation of the 6D camera position from characteristic values that are obtained from the measured dot positions and that describe the distorted grid in the camera image. The equations for calculating the position result from an inverse optical imaging model of the camera 1 and the laws of geometrical optics:

Step 500: XY fine position evaluation:

The position in the X and Y directions is calculated from the XY coarse position and the position of the grid in relation to the position of the optical axis (image center point).

Step 600: Z-angle evaluation from the angle of the (interpolated) straight lines in the image center point

Step 700: Evaluation of Z position and XY angle

Step 710: Derivation of interpolated characteristic values from the bunch data that describe the perspectively distorted grid in the image center point:
Grid spacing of the straight lines of both straight line bunches
Angular divergence of the straight lines of both straight line bunches

The camera position in the Z direction is mainly determined from the grid spacing of the straight lines in the image center point. The camera angles φ_{X} and φ_{Y} are mainly ascertained from the angular divergence of the two straight line bunches in the image center point.

An iterative algorithm numerically solves the system of equations with which the quantities Z, φ_{X} and φ_{Y} are linked.

Step 800: Output of the 6D position information and the optional validity information resulting from the results of numerous diagnostic functions in the sequence.

With minimal computational effort, the algorithm concentrates the camera image data to a few pieces of data relevant for determining position, increases the accuracy through interpolation while doing so, and behaves robustly in the event of camera image disturbances. The following sequence positions are of particular importance (numerical values given as examples):
Sequence position I: Input data camera image (e.g., 200×200 pixels)
40,000 values
Sequence position II converts the camera image data into dot data

### (Step 300):

2,250 values
Sequence position III converts the dot data into beam data

### (Step 400/500):

90 values
Sequence position IV converts the beam data into bunch data

### (Step 400/500):

12 values
Sequence position V converts the bunch data into a 6D position

### (Step 500/600/700):

6 values

The sequence positions II-V have the following special features.

### Sequence Position II:

a) Quickly locating the dots in the camera image 3 by mathematical modeling of the perspectively distorted code grid in the code arrangement 2. The method is based on the dot positions already measured.
Advantages: quick location of the dots, no time-consuming search in the pixel grid. Robust against disturbances in the camera image: dots are classified as “not valid” if they are not found at the expected position. Invalid dots are not processed further, but generally do not hinder the further sequence

b) Stack-based algorithm for fast and robust search of dots in the code grid of the code arrangement 2.
Advantage: error-tolerant, since the search process does not stop when erroneous dots are found, but rather encloses them on all sides. Precise (high yield of found dots per reading field) and robust (through prioritized detection of dots with many valid neighbors)

c) Function Center_Pos: fast method for sub-pixel-accurate position and area determination of dots in the camera image
Advantage: fast (few pixel accesses), accurate (due to sub-pixeling), robust (use of dynamic contrast thresholds instead of gray value thresholds)

d) Rectification of the dot positions instead of rectifying the entire camera image.
Advantage: fast (rectification of only 225 positions instead of all 40,000 pixels in the camera image)

e) Local normalization of the dot area to the area of the dot grid cell. The normalized dot area is used to classify the dots.
Advantage: robust reading of the digital code (classification of the dots is tolerant to perspective distortion and to a change in the distance between the camera and the dot)

f) Redundant reading of digital codes, error detection and partial error correction
Advantage: low error rate in case of disturbances in the camera image, correct reading despite invalid dots.

### Sequence Position III and IV:

g) Compressed and precise representation of the dot positions extracted from camera image 3 as bunch parameters (only 12 values)
Advantage: fast (due to small amount of data), precise (through averaging and best-fit interpolation in two steps: dots to best-fit lines and best-fit lines to straight line bunches), error-tolerant and robust (through exclusion of invalid dots from further processing).

### Sequence Position V:

h) Mathematical procedure for transforming the 12 bunch parameters into a 6D position.

The advantages include some or all of the following improvements:
Full 6D position measurement, absolute position information.
Simultaneous recording of all dimensions with one measurement process (in one camera image).
High position measurement rate and low latency time. The method requires only a small number of calculation steps by a computer. With an embedded computer, typical measurement rates of approximately 100 Hz-10,000 Hz are achieved, so that the sensor can also be used in a closed position control loop, for example.

The method also achieves a high reading speed by minimizing the number of accesses to camera pixels. No time-consuming surface-covering camera image operations are performed. In addition, the amount of data is significantly reduced with each processing step.
High reading reliability through redundant reading of the point code. The position detection is also possible in the event of disturbances in the field of view of the camera, such as local occlusions, invalid dots or under unfavorable lighting conditions.

By checking the validity of the processing steps, faulty states are detected and the output of unreliable position values is prevented.
High accuracy of position measurement in all degrees of freedom. This is achieved through various measures such as
Averaging over numerous dots per camera image 3, for example more than 100 or 1000
Classification of dots according to validity, exclusion of invalid dots from further processing
Sub-pixel-accurate determination of the position of the edges of the dots
Use of contrast thresholds instead of gray value thresholds, resulting in high robustness against local changes in image brightness
Round dots, so that there are hardly any center point errors when tilting or rotating the code plane
Unlimited measuring range in φ_{Z}
Almost unlimited measuring range in X and Y. For example, when using a code with a code cell of 9×9 dots and a dot grid of 2.5 mm, a measuring range of 550,000 km×550,000 km is achieved.
Large angle measuring range φ_{X}, φ_{Y} of about +/−50°, with high accuracy. Extension to 360° through spatially distributed code arrangements on the object.
An inverse imaging model based on geometrical optics is used to calculate the position of the camera from the camera image data.
The method does not require active illumination, so that camera images taken under ambient light, for example with a smartphone, can be processed.
Minimal error rate. The method determines the validity of a position measurement value by checking each processing step for errors and plausibility using various diagnostic methods. The validity is output together with the position measurement value. The aim is to output only valid measured values for further processing.

### Further Advantages are:

A single measuring sensor, in particular designed as a camera 1, detects the position of one or more objects in six dimensions each. Compared to a system with many distributed sensors for detecting individual degrees of freedom, the installation effort and complexity of the overall system are reduced, resulting in cost advantages.
Saving system components by detecting all 6 degrees of freedom. For example, a rotary angle encoder usually requires a rotary bearing for the measuring axis so that lateral position deviations of the code disk do not lead to measurement errors. With the proposed method, mechanical guidance can be eliminated, since the full 6D position information of the code disk is simultaneously detected as a code arrangement. A lateral position deviation of the sensor does not lead to an error in the angle measurement. This reduces the cost and mechanical complexity of the position measuring system.
A positioning system can be implemented in which the distribution of the position sensors over a plurality of axes is not structurally possible. For example, a levitating planar robot can be realized that can be positioned in six dimensions without any structural connection between the robot and the underlying stator.
The simultaneous recording of a plurality of dimensions reduces measurement errors that can arise in distributed sensor systems due to different measurement times.
The cost of the sensor is largely independent of the number of degrees of freedom measured. Therefore, it can also be used advantageously in applications that require fewer than 6 degrees of freedom. The additional information provided enables additional functions, such as self-diagnosis of systems or permanent monitoring of the operating status (“condition monitoring”).
The method is scalable, e.g., by varying the grid spacing of the code arrangement and adapting the imaging optics to the code arrangement. The resolution can vary over many orders of magnitude, for example from the nanometer range (application example: nanometer positioning system) to the m range (application example: automated landing of an aircraft or drone at an airfield, where the airfield is marked with a code arrangement).
The ratio of resolution to measuring range can span many orders of magnitude. For example, if a position measuring system with 10 nm resolution is combined with a 10 m long code arrangement, the ratio of resolution to measuring range is 1:10⁹.
A sensor with this method has a high degree of flexibility in use, as it can be easily installed and configured for specific applications through parameterization. This is advantageous in particular when operating conditions change frequently.
The method can read additional information contained in the position code. For example, object identification data can be read in addition to the position.
With cyclic image capture, the method provides an independent position estimate for each individual image; it does not rely on prior information from previous images. Therefore, the measurement rate corresponds to the refresh rate.

The method enables the localization of the at least one camera 1 with respect to at least one object 8 in six degrees of freedom, wherein at least one code arrangement is applied to the surface of each object 8. A camera 1 detects the code arrangements 2 on the objects 8 and displays them completely or partially in the camera image 3. Using the proposed method and other common mathematical/technical methods, the 6D position of the objects 8 is calculated from the camera image 3.

The code arrangement 2 forms a flat, digitally coded scale. It contains a plurality of different symbols, preferably circular symbols (dots), which are arranged in a regular, preferably square grid and enable position determination in 6 degrees of freedom.

The camera 1 includes at least
an imaging sensor element, usually a camera chip, in particular the image sensor 12.
an imaging system that projects the scale sharply and with high contrast onto the sensor element, in particular the objective 9. The imaging system includes, in particular, a wide-angle lens as objective 9, since a central perspective image is required to determine all six degrees of freedom.
An interface for outputting the camera image data and/or the camera image 3.

Optionally, the camera system of the camera 1 includes
a lighting system, in particular for illuminating the code arrangements. This makes the camera 1 more independent of the ambient lighting conditions. Flash mode enables short measuring times so that even fast-moving objects can be detected. Light-emitting diodes, for example, are used as lighting sources.
Means for shielding from extraneous light, e.g., a diaphragm or optical filters. A spectral filter can be provided in the beam path of the imaging system so that only light of a limited wavelength range reaches the sensor element. Ideally, single-color lamps with the same wavelength characteristics as the color filter are used.

In addition, a computer system is required as a digital data processing device for information processing, e.g., designed as a control unit. The computer system receives the digitized camera image data of the camera image 3 as input information, and at the output it provides the ascertained 6D positions of the identified objects and, optionally, an assessment of the validity of the position measurement values.

In the computer system, the method is implemented as an algorithm. The algorithm is executed either on external request or cyclically, for example in a fixed time grid to record the movement paths of objects (tracking).

The computer system can be implemented, for example, as an embedded system, parallel computer, GPU, FPGA, ASIC or cloud system. A smartphone can also be used as a complete system for position detection, where the integrated camera 1, possibly with active illumination, is used to capture images. The method can be implemented in a smartphone application and executed embedded in the smartphone or in the cloud.

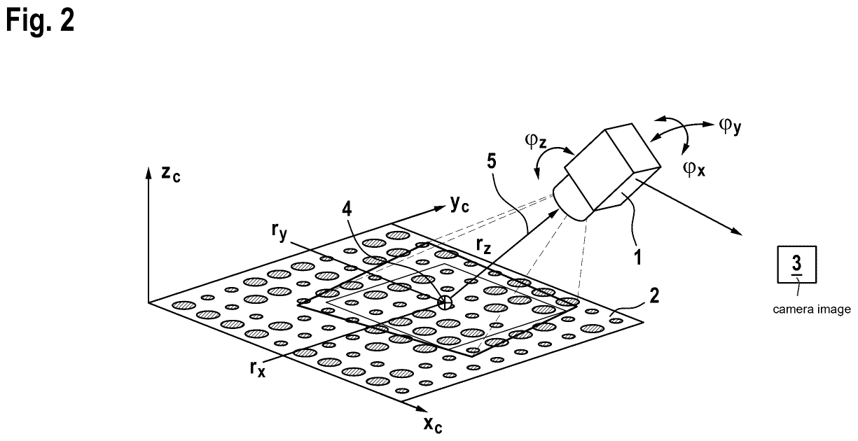

FIG. 2 shows a typical arrangement for determining the absolute position in 6 degrees of freedom. The camera 1 captures the camera image 3 of a planar code arrangement 2. From the perspectively distorted camera image 3, the method according to the present invention calculates the 6D position of the camera in the coordinate system of the code arrangement 2 and outputs it as a position vector (r_{X}, r_{Y}, r_{Z}) and angle vector (φ_{X}, φ_{Y}, φ_{Z}).

The coordinates r_{X} and r_{Y} are indicated in the rectangular coordinate system (X_{C}, Y_{C}) of the code arrangement 2. They designate the intersection point 4 of the optical axis 5 of the camera 1 with the plane in which the code arrangement lies. Since the optical axis 5 is perpendicular to the plane of the image sensor 12, it can be designated by a point 7 in the camera image 3.

The method ascertains the intersection point (X, Y) even if the code arrangement 2 is shown only at the edge of the image field and not at the location of the optical axis 5.

The distance rz lies on the optical axis 5 and extends from the intersection point 4 to the optical center of the objective of the camera 1. Since the optical axis 5 is not always perpendicular to the code arrangement 2, r_{Z} with (X_{C}, Y_{C}) is generally a non-orthogonal coordinate system. Using the angle vector, the position vector (r_{X}, r_{Y}, r_{Z}) can be transformed into a rectangular coordinate system.

The method can be used to locate a plurality of simultaneously captured objects 8 in the field of view of the camera, even if they partially overlap. In order to be able to read the position, at least an area the size of a code parcel (e.g., 7×7 dots) must be visible in the camera image 3.

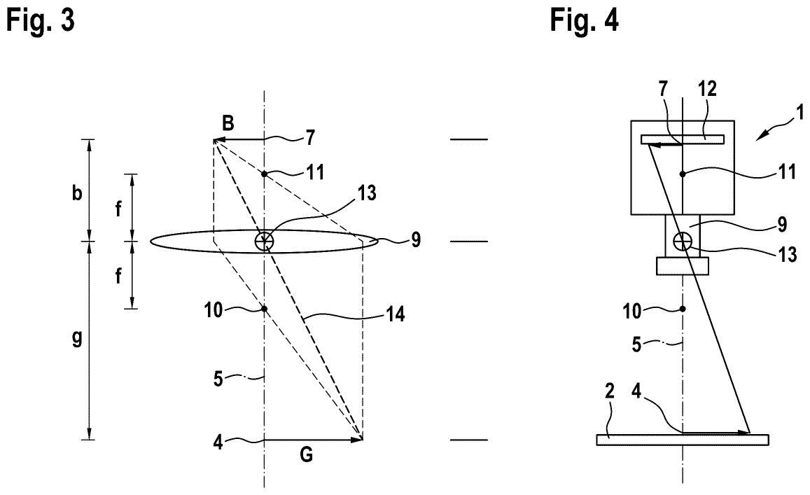

FIGS. 3 and 4 schematically show the beam path of the camera 1. FIG. 3 shows the camera 1 with an objective 9 and an image sensor 12, the viewing direction directed downwards onto the code plane of the code arrangement 2. The optical axis 5 is shown as a dot-dash vertical line, the focal points of the objective 9 as points 10,11.

A vector arrow G on the code plane of the code arrangement 2 is imaged as a vector arrow B onto the image sensor 12 according to the laws of geometrical optics. A line of sight 14 intersects the optical axis 5 at a point which is referred to here as the optical center 13 of the objective 9.

FIG. 4 shows the complete beam path; the objective 9 is simplified to a lens. Geometrical optics, together with the intercept theorem and the lens equation, forms the basis for the mathematical method for determining position. The following applies:

$$B / G = b / g and 1 / f = 1 / b + 1 / g$$

where:
B Image size
b Image distance
G Object size
g Object distance
f Focal length

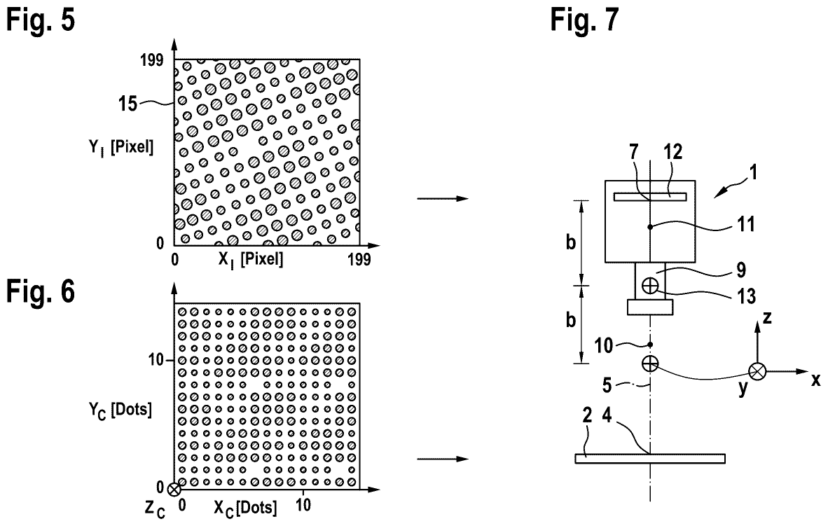

### FIGS. 5, 6, 7 Illustrate the Coordinate Systems Involved:

The two-dimensional coordinate system 15 of the image sensor 12 is defined by the axes (X_{I}, Y_{I}) of the camera chip. A position on the image sensor 12 is specified in pixels, with the pixel rows and columns of the camera chip being consecutively numbered. In this example, an image sensor 12 with 200×200 pixels is assumed. The numbering results in an integer X and Y position value for each pixel. Sub-pixeling, a method for interpolating gray values between adjacent pixels, can also result in real numbers appearing as camera positions in the evaluation. To convert the unit of the position from [pixel] to [m], the position is multiplied by the distance between adjacent pixels p_{grid} on the camera chip in the unit [m/pixel]. The pixel distance p_{grid} is a property of the image sensor 12. Each pixel provides an integer gray value.

The coordinate system 16 of the code arrangement 2 (X_{C}, Y_{C}) is spanned by the main axes of the code arrangement 2, which correspond to the square grid of the dots. It is expanded by a third axis Z_{C} to form a three-dimensional coordinate system which is perpendicular to the code arrangement 2, wherein the code arrangement 2 is arranged at Z_{C}=0. The unit is either [dots], i.e., the consecutive numbering of the dot rows and columns, or [m] after multiplication with the dot grid spacing c_{grid} in [m/dot]. The code arrangement 2 uniquely encodes the local position in the coordinate system (X_{C}, Y_{C}).

The three-dimensional camera coordinate system (X, Y, Z) 17 is firmly connected to the camera 1. Its origin lies on the optical axis 5 between the image sensor 12 and the code arrangement 2, at a distance of twice the image distance b from the image sensor 12. The optical axis 5 forms the Z-axis, the camera 1 looks in the direction −Z.

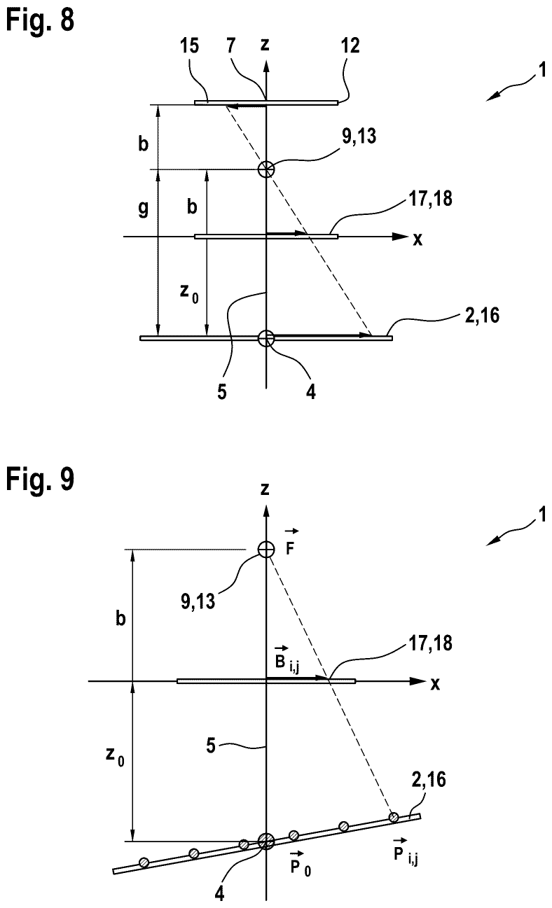

The coordinate system for the imaging model in FIG. 8 corresponds to the camera coordinate system 17 (X, Y, Z). Where b is the image distance of camera 1. The image plane is located at the height (0, 0, 2b) and is parallel to the X/Y plane of the camera coordinate system 17. As a model, a further “virtual” image plane 18 can be constructed in the (X, Y) plane of the coordinate system 17, wherein the virtual image is mirrored point-symmetrically with respect to the real image on the image sensor 12 relative to the image center point.

The code plane of the code arrangement 2 is situated at the height (0, 0, z₀) where (z₀<0). For the camera orientation (0°, 0°, 0°) the code plane is parallel to the X/Y plane of the camera coordinate system 17 and the axes (X_{C}, Y_{C}) of the coordinate system 16 of the code arrangement 2 point in the same direction as the axes (X_{I}, Y_{I}) of the coordinate system 15 of the image sensor 12.

The method ascertains the 6D position of the camera
in translation: (r_{X}, r_{Y}, r_{Z}) and
in rotation: (φ_{X}, φ_{Y}, φ_{Z}).

The center of rotation, to which the tilt and angle of rotation phix and phy of the camera 1 relate, is at the point (0, 0, z₀). The roll angle phiz is measured around the optical axis 5.

FIG. 9 shows the imaging model with tilted code plane of the code arrangement 2.

The value r_{Z} is the distance between the center of rotation (0, 0, z₀) and the optical center (0, 0, b) of the objective, so that: r_{Z}=b−z₀.

Based on the intercept theorem and geometrical optics, the mapping of a point (x₀, y₀) in the code plane to a point (B_{X}, B_{Y}) in the image plane can be mathematically described as an imaging equation in the camera coordinate system 17:
Optical center 13 of the objective 9:

$$\vec{F} = ( \begin{matrix}0 \\ 0 \\ b\end{matrix} )$$

Two-dimensional coordinates of dots or points in the plane of the code arrangement in the coordinate system 16 of the code arrangement 2

$${\vec{P}}_{i , j}^{′} = {\vec{P}}_{0} + ( \begin{matrix}i \\ j\end{matrix} ) \cdot {c}_{grid} = ( \begin{matrix}{x}_{0} + i \cdot {c}_{grid} \\ {y}_{0} + j \cdot {c}_{grid}\end{matrix} )$$

where \vec{P}₀=(x₀, y₀) the centroid of a selected base symbol and i, j integers.
Spatial coordinates of dots or points in the camera coordinate system 17:

$${\vec{P}}_{i , j} = [ \underline{R} ( \begin{matrix}{x}_{0} + i \cdot {c}_{grid} \\ {y}_{0} + j \cdot {c}_{grid} \\ 0\end{matrix} ) ] + ( \begin{matrix}0 \\ 0 \\ {z}_{0}\end{matrix} )$$

with the rotation matrix for vectors in three-dimensional space:

$$\underline{R} = ( \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ) = ( \begin{matrix}cos {φ}_{Y} cos {φ}_{Z} & sin {φ}_{X} sin {φ}_{Y} cos {φ}_{Z} + & sin {φ}_{X} sin {φ}_{Z} - \\ & cos {φ}_{X} sin {φ}_{Z} & cos {φ}_{X} sin {φ}_{Y} cos {φ}_{Z} \\ - cos {φ}_{Y} sin {φ}_{Z} & cos {φ}_{X} cos {φ}_{Z} - & cos {φ}_{X} sin {φ}_{Y} sin {φ}_{Z} + \\ & sin {φ}_{X} sin {φ}_{Y} sin {φ}_{Z} & sin {φ}_{X} cos {φ}_{Z} \\ sin {φ}_{Y} & - sin {φ}_{X} cos {φ}_{Y} & cos {φ}_{X} cos {φ}_{Y}\end{matrix} )$$

Pixel in the virtual image plane in the camera coordinate system 17:

$$\vec{B} = ( \begin{matrix}{B}_{X} \\ {B}_{Y} \\ 0\end{matrix} )$$

Line of sight from \vec{F} to \vec{P}_{i,j}:

$$\vec{G} = \vec{F} + λ ( {\vec{P}}_{i , j} - \vec{F} ) ; λ = 0 … 1$$

Intersection of the line of sight with the virtual image plane 18:

$$( \begin{matrix}{B}_{X} \\ {B}_{Y} \\ 0\end{matrix} ) = ( \begin{matrix}0 \\ 0 \\ b\end{matrix} ) + λ [ \underline{R} ( \begin{matrix}{x}_{0} + i \cdot {c}_{grid} \\ {y}_{0} + j \cdot {c}_{grid} \\ 0\end{matrix} ) + ( \begin{matrix}0 \\ 0 \\ {z}_{0}\end{matrix} ) ( \begin{matrix}0 \\ 0 \\ b\end{matrix} ) ]$$

$$0 = b + λ ( {R}_{31} ( {x}_{0} + i \cdot {c}_{g r i d} ) + {R}_{32} ( {y}_{0} + j \cdot {c}_{g r i d} ) + {z}_{0} - b )$$

$$⇒ λ = - b / ( {R}_{31} ( {x}_{0} + i \cdot {c}_{g r i d} ) + {R}_{32} ( {y}_{0} + j \cdot {c}_{g r i d} ) + {z}_{0} - b )$$

Virtual image of the point or dot:

$$( \begin{matrix}{B}_{X} \\ {B}_{Y}\end{matrix} ) = \frac{- b}{( {R}_{31} ( {x}_{0} + i \cdot {c}_{g r i d} ) + {R}_{32} ( {y}_{0} + j \cdot {c}_{g r i d} ) + {z}_{0} - b )} \cdot ( \begin{matrix}{R}_{11} ( {x}_{0} + i \cdot {c}_{g r i d} ) + {R}_{12} ( {y}_{0} + j \cdot {c}_{g r i d} ) \\ {R}_{21} ( {x}_{0} + i \cdot {c}_{g r i d} ) + {R}_{22} ( {y}_{0} + j \cdot {c}_{g r i d} )\end{matrix} )$$

For the real image, the negative sign must be omitted: for the intersection point 4 with the index (i=0; j=0) the image coordinates in the real image are obtained:

$$( \begin{matrix}{B}_{X} \\ {B}_{Y}\end{matrix} ) = \frac{b}{( {R}_{31} {x}_{0} + {R}_{32} {y}_{0} + {z}_{0} - b )} \cdot ( \begin{matrix}{R}_{11} {x}_{0} + {R}_{12} {y}_{0} \\ {R}_{21} {x}_{0} + {R}_{22} {y}_{0}\end{matrix} )$$

### 2.4.3 Code Arrangement

The method requires a surface-coded scale in the code arrangement 2, a sub-region of which is read with an imaging sensor, for example the camera 1, so that the position of the sensor and/or of the camera 1 with respect to the scale can be ascertained in up to six spatial directions from the image information. Further details on the code arrangement 2 can be found in the applicant's publication DE 10 2016 216 221 A1, the content of which is incorporated into the present disclosure by reference, in particular with regard to the design of the code arrangement as well as the decoding and the variants.

The coded scale, designed as a sensor-readable marking, is applied as a code arrangement 2 to a surface that extends substantially in two dimensions, but may also have curvatures. For better description, it is assumed in the following that the coded scale is printed as an optically readable pattern on a flat surface, without limiting the claim to other marking and sensor principles and curved surfaces.

The coded scale of the code arrangement 2 is formed by arranging different base symbols in a regular grid. The base symbols carry two pieces of information: their shape encodes digital information and their centroid marks a specific position on the surface.

In a simple case, the digital information is encoded in a binary number system with base b=2. In this case, only two base symbols 20 are used, e.g., a small and a large circle, which symbolize the values “0” and “1.” Its centroid (the center point of the circle) marks a grid point on the surface.

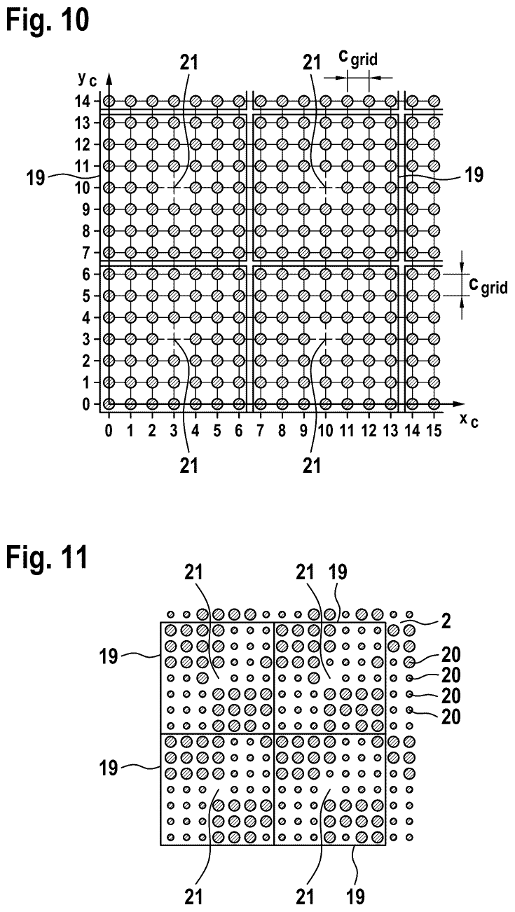

The centroids of the base symbols 20 form a periodic two-dimensional pattern on the scale plane of the code arrangement 2, for example in a square grid as in FIG. 10, with the same base spacing c_{grid} of adjacent symbols in the X and Y directions.

By dividing the plane into equally sized, area-filling parcels 19, the base symbols within a parcel 19 are combined into a logical unit. Square parcels 19 are preferably used. FIG. 10 shows a point grid with square parcels 19, each of which can accommodate 7×7 binary symbols, which corresponds to a maximum information content of 49 bits. The lines and squares shown in FIG. 10 are for illustration only and are not shown in the real code arrangement 2. FIG. 11 shows an example of a code arrangement 2 without lines with the base symbols 20 in the parcels 19.

The regular arrangement of the base symbols 20 is overlaid by a regular arrangement of parcel symbols 21, by marking each parcel 19 in the same way with a parcel symbol 21. The parcel symbol 21 can be represented for example by omitting a base symbol 20.

In FIG. 10, 11, the parcel symbol 21 consists of a blank space in the point grid, located in the center of each parcel 19. The parcel symbol 21 allows the location of the parcel 19 to be detected in order to read out the base symbols 20 along a reading track in the correct order. Since the parcel symbol 21 occupies one grid space, the information content of a parcel 19 is reduced to 48 bits in this example.

A reading field 22 is a field on the coded scale of the code arrangement 2 which is at least the size of a parcel 19. It is tied to the point grid, but not to the grid of parcels 19.

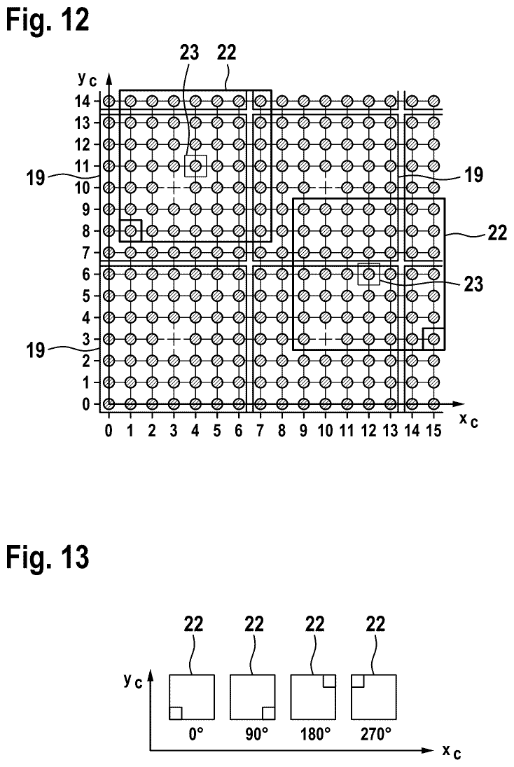

FIG. 12 shows a point grid of a code arrangement 2 with two examples of reading fields 22. The position of the reading field 2 in the coordinate system of the point grid is defined by its center point position 23. It can vary in integer steps of the base distance c_{grid}.

In addition, the reading field 22 has an angular position with respect to the coordinate system of the point grid, which can vary in steps of 90° in the case of a square grid. In FIG. 12, the angular position is visualized by marking a corner of the reading field. The possible angular positions are shown in FIG. 13. The reading fields 22 shown as examples in FIG. 12 are clearly described by the following information:
Reading field 22, left: position=(4,11); angular position=0°
Reading field 22, right: position=(12, 6); angular position=90°

The code of the code arrangement 2 is constructed such that the base symbols 20 in a reading field 22 contain sufficient information to digitally encode the location (X, Y) and the direction of the reading field 22 in the coordinate system 16 of the code arrangement 2. X and Y are indicated as integer multiples of the base distance c_{grid} (coarse position). The fine position in fractions of the base distance c_{grid} as well as the exact angle in fractions of 90° is not digitally coded; it is ascertained by an exact determination of the location of the base symbols 20 in the camera coordinate system 17.

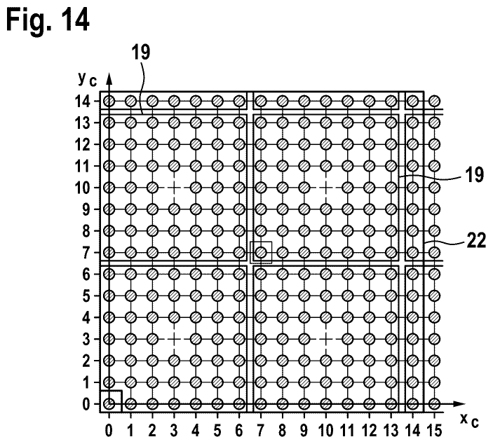

FIG. 14 shows as an example a reading field 22 with 15×15 spaces for base symbols 20. It provides more information than does the minimum required reading field 22 having the size of a parcel 19, here 7×7 symbols. The redundant information is used for error detection and/or error correction.

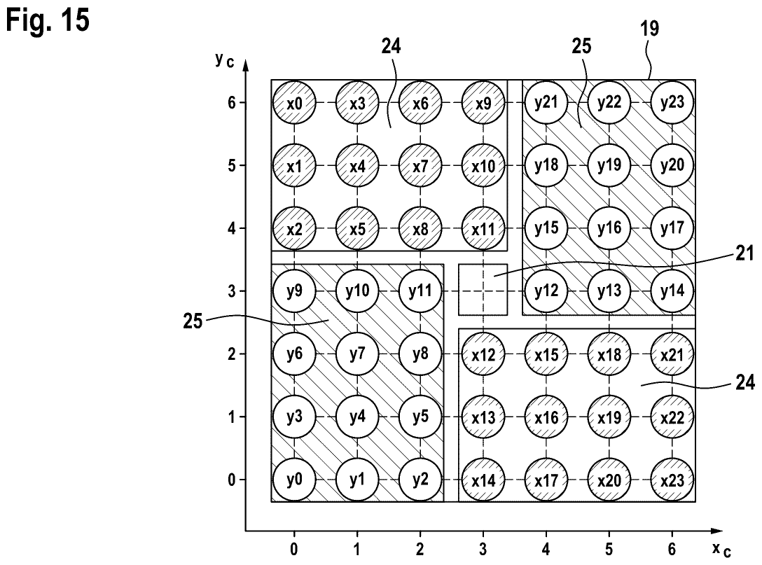

FIG. 15 shows an example of the structure of a parcel 19 with 7×7 grid points. The parcel symbol 21 is situated in the middle of the parcel 19. The two fields 24 indicate the X parcel regions in which the consecutive code for the position in the X direction is displayed. The X parcel regions comprise 24 grid points; accordingly, they represent a code having a length of 24 bits.

To read the code, the 20 base symbols are read column by column from left to right and within each column from top to bottom. The reading order in the X parcel regions 24 (reading track) is in grid point coordinates (X_{C}, Y_{C}): (0.6); (0.5); (0.4); (1.6); (1.5); (1.4); (2.6); (2.5); (2.4); (3.6); (3.5); (3.4); (3.2); (3.1); (3.0); (4.2); (4.1); (4.0); (5.2); (5.1); (5.0); (6.2); (6.1); (6.0).

The two fields 25 indicate the Y parcel regions in which the consecutive code for the position in the Y direction is displayed. The reading order corresponds to that of the X parcel regions 24, but is rotated 90° counterclockwise. The reading track thus runs line by line from bottom to top and within each line from left to right.

The code from the X parcel regions 24 (X code) is a sub-sequence having t=24 digits length from an overall sequence of g digits, where g is much larger than t. The number g is sufficiently large that the X parcel regions 24 of all parcels 19 adjacent in the X direction can be completely filled. In particular, g is greater than fifty, in particular greater than a thousand, and especially greater than one million. The contents of the X parcel regions 24 of parcels adjacent in the Y direction are identical. The overall sequence is designed such that each sub-sequence of t consecutive base symbols 20 read forward is contained exactly once in the overall sequence and each sub-sequence read backward is not contained in the overall sequence read forward.

The code from the Y parcel regions 25 (Y code) is shown inverted, i.e., each digit z is replaced by the digit (b-1-z). For the binary system with b=2, this corresponds to a bitwise inversion. The inverted Y code is a sub-sequence with t=24 bits length from an overall sequence, wherein the same overall sequence can be used as for the X code. The inverted Y code also occurs only once in the entire sequence and does not occur in the entire sequence when read backwards. The contents of the Y parcel regions 25 of parcels 19 adjacent in the X direction are identical.

The overall sequence is designed in such a way that a checksum of a sub-sequence is less than half of the maximum possible checksum of a sub-sequence. In particular, the checksum for any sub-sequence taken from the overall sequence is less than half of the maximum possible checksum of a sub-sequence. For example, the checksum of any sub-sequence of length t in a number system with base b is less than q=t·(b−1)/2.

The sub-sequences of the overall sequence encode a coordinate value, for example the X coordinates of the starting position of the reading process. Likewise, a sub-sequence of the inverted overall sequence encodes a Y coordinate, for example the position from which the sub-sequence is read. The X code and the Y code read in a parcel 19 are assigned to the X and Y coordinates of a reference point in the parcel 19, for example the center point of the reading field.

Each reading field 22 contains exactly one parcel symbol 21, t base symbols from X parcel regions 24, and t base symbols from Y parcel regions 25. From the position of the parcel symbol 21, the position of the parcel grid and thus the position of the X and Y parcel regions 24, 25 in the reading field 22 as well as the associated reading sequence can be derived. The base symbols 20 read according to the reading order result in a sequence of digits with t digits, which (after inversion if necessary) is a sub-sequence of the overall sequence.

If the orientation of a reading field 22 is unknown, it is initially not known which of the two axes is the X axis and which is the Y axis. This is ascertained by calculating the checksum of the read code and comparing it with q: the checksum of an X code is less than q, the checksum of a Y code is greater than q. From the direction of the read codes relative to the overall sequence (forward or backward), the direction of the coordinate axes of the reading field 22 with respect to the coordinate axes of the code arrangement 2 is unambiguously derived.

In this way, the position and orientation of a reading field 22 in the coordinate system 16 of the code arrangement 2 can be determined, the position in integer steps of the grid width and the orientation in integer steps of 90°

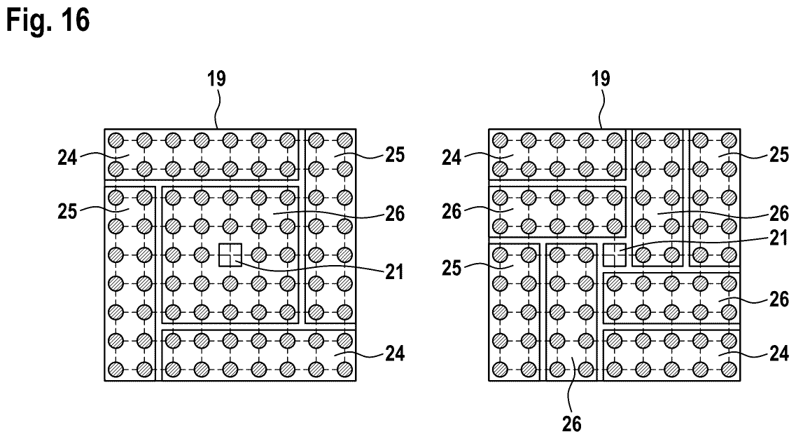

In FIG. 16, on the left parcels 19 with 9 rows and 9 columns are shown. In addition to the parcel regions X and Y 24, 25, which represent the position code for the corresponding axis of the coordinate system 16, a parcel region for additional data 26 is provided. It comprises (5×5) grid points, with the middle grid point left out for the parcel symbol 21, so that 24 grid points remain, each of which can accommodate a base symbol 20. In this way, in each parcel 19, 24 bits of additional items of information can be displayed which are not required for determining position and are read in a fixed order. FIG. 16 shows on the right another code arrangement 2 with additional data. Here, four parcel regions 26, each with 10 grid points, are provided for additional data, so that a total of 40 bits of additional information are available per parcel 19.

The algorithm for position determination is shown in FIG. 1 as a sequence of data processing steps, which are explained in detail below on the basis of exemplary embodiments. Standard methods of mathematics and image processing as well as for diagnosis and error detection are not explained in detail.

The method is in particular optimized for high accuracy of position determination and rapid execution. The sequence of steps quickly reduces the data volume, which supports rapid execution.

In the sequence position I in step 100, the digital image data are transferred as a gray value matrix from the camera 1 to the computer. Step 200 is used to coarsely check the validity of the image data using characteristic values. Further image processing steps may follow, e.g., to prepare the image data or to segment them into individual code regions. These are not shown in detail here. The data volume for a 200×200 camera image 3 is 40,000 pixels and thus 40,000 bytes in gray values.

In the sequence position, the symbols (dots) contained in the image are located and entered, according to their arrangement in the dot code grid, into a dot matrix which corresponds to the size of a reading field (here: 15×15 dots). Each symbol is measured for its position and area. The positions are rectified to correct objective distortion. The areas of the symbols are normalized to eliminate the influence of perspective distortion. The symbol type is classified on the basis of the normalized area. This reduces the data volume to 225 dots with meta-information, and thus 9000 bytes. In order to classify unoccupied grid points or incorrectly imaged symbols as such, a local model of the dot code grid in the camera image is created from the positions of the successfully identified symbols. Within the reading field, symbols are searched for at all grid points of the model. Due to local occlusions, image errors or the limitation of the image field, not all symbols can always be identified. The corresponding grid positions are then classified as “not valid.”

In the sequence position III, best-fit lines (beams) are adapted to the rows and columns of valid dots in the reading field 22. Each best-fit line is described by a linear angle in the image field of the camera 1 and an intersection point with the X or Y axis of the image field coordinate system. Each reading field 22 provides two bunches of best-fit lines, corresponding to the two main axis directions of the code arrangement 2. In this example, each straight line bunch contains up to 15 straight lines. Thus, the position data of 15×15=225 dots are reduced to the data of 15+15=30 best-fit lines.

In the sequence position IV, the straight lines of each bunch are interpolated by two second-degree polynomials: one polynomial describes the linear angles, a second describes the axis intersection points of the straight lines of a straight line bunch. The polynomial parameters of the two bunches are represented by 12 real values, which corresponds to a reduction by a factor of 5 compared to the straight line representation.

In the sequence position V, an inverse mathematical imaging model is also used to calculate the 6D position of the camera 1 from the polynomial parameters of the two straight line bunches. In addition, the validity of the position value is estimated by evaluating a large number of diagnostic results from the individual steps of the program sequence. The 6D camera position and validity are output to the higher-level system in step 800.

### Step 200—Check/Validity Test of Image Data

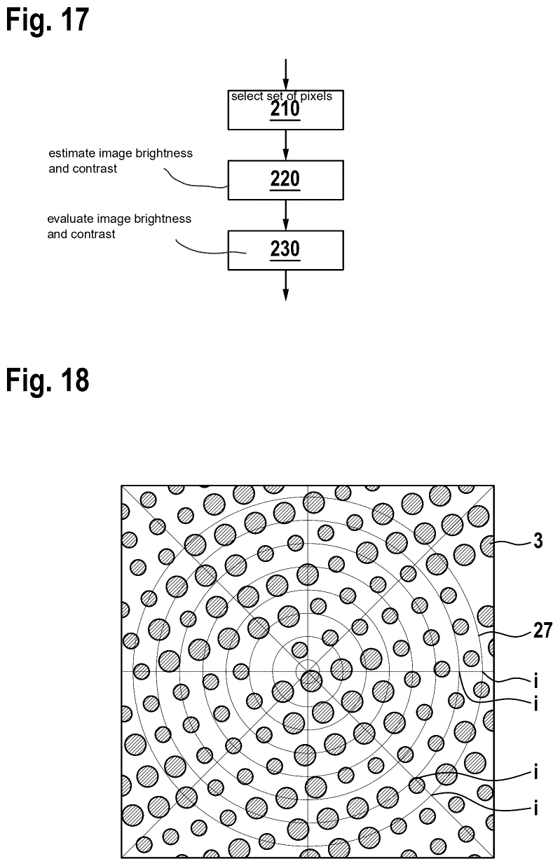

Statistical characteristic data are used to check whether an evaluable camera image 3 is available (see flow chart in FIG. 17). In this example, the image brightness B and the contrast C are estimated and checked for compliance with specified limit values. If the specified limit values are exceeded, further evaluation is aborted and the result is classified as invalid.

To save computing time, only a small number of pixels are included in the ascertaining of the characteristic values, for example the gray values at the intersection points of the straight lines and circles in the intersection point pattern 27 (FIG. 18).

In substep 210, a set of pixels is selected which are determined according to an arbitrary intersection point pattern 27. The pixels at the intersection points in the intersection point pattern 27 are used. Thus, Gᵢ is a grayscale value of the pixels at positions i, i=1 . . . n.

In substep 220, the image brightness B and the contrast C are estimated:

$$B = mean ( {G}_{i} )$$

$$C = \frac{max ( {G}_{i} ) - min ( {G}_{i} )}{max ( {G}_{i} ) + min ( {G}_{i} ) + 1}$$

In substep 230, the image brightness B and the contrast C are evaluated with the following conditions:

$$( B \leq {B}_{min} ) or ( B \geq {B}_{max} )$$

$$( C < {C}_{min} )$$

If one of the conditions is met, further evaluation is aborted and the result is classified as invalid.

### Dot Data Detection/Steps 310 to 350:

The aim is to identify, measure and classify the dots as base symbols 20 in a reading field 22 of a given size (here: 15×15 grid points). As a result, a two-dimensional dot matrix 29 or generally a base symbol matrix with the data of the dots is output, wherein the indices of the matrix 29 are assigned to the rows and columns of the code arrangement 2. Characteristic values are ascertained for each dot.

The Dot.Typ variable contains the classification result. If Dot.Typ is positive, the dot was assessed as valid:
Dot.Typ=2: large dot; logical “1”
Dot.Typ=1: small dot; logical “0”
Dot.Typ=0: missing dot; parcel symbol 21

If Dot.Typ is negative, the dot could not be unambiguously identified.

In substep 310, a starting base/starting field (launch pad) 28 is first searched for in the image region and/or in the reading field 22 of the camera image 3 with the dot code of the code arrangement 2. This is understood as an array of, for example, 3×3 adjacent dots of type 1 or 2.

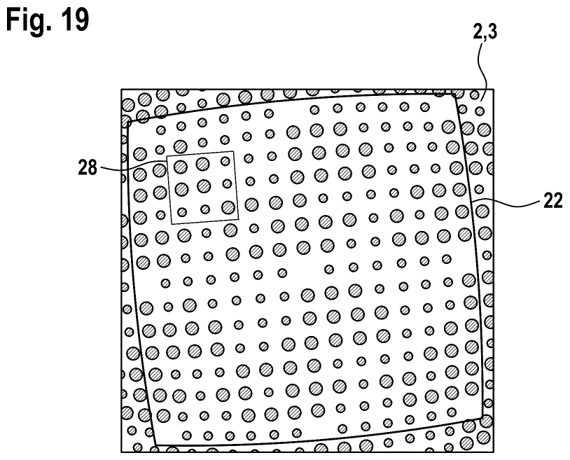

FIG. 19 shows an example of a camera image 3 with an identified starting base 28 and the reading field 22, in which, starting from the starting base 28, the dots are searched for as base symbols 20.

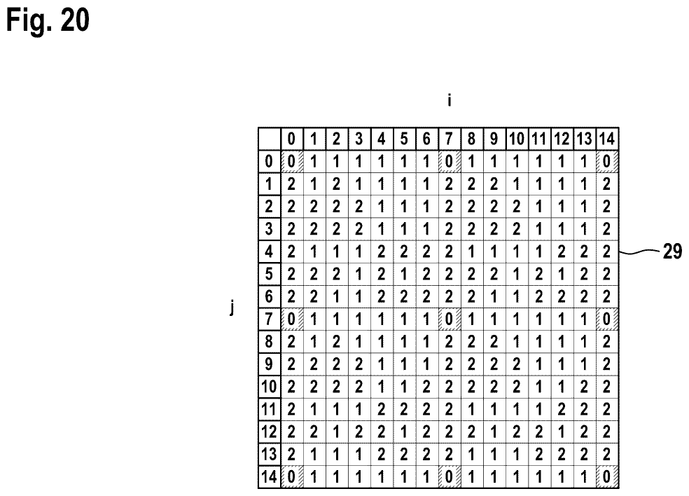

In substep 320, the starting base 28 is used to build a local model of the point grid in the vicinity of the starting base 28. At the adjacent grid spaces predicted by the model, further dots are searched for, are precisely measured when successfully found, and are entered into the dot matrix 29 as valid dots. This process is repeated cyclically so that more and more valid dots are registered around the starting base 28 until the reading field 22 of 15×15 dots is completely acquired. The search process is robust against local reading errors: if individual dots are not unambiguously identifiable or go past the edge of the image field, they are marked as invalid in the dot matrix 29 and are excluded from further processing. FIG. 20 shows the result of a successfully classified dot matrix 29 based on the camera image 3 in FIG. 19.

In substep 330, the center point positions and areas of the dots are measured.

Substep 340 converts the measured positions of all valid dot positions in the reading field 22 into rectified coordinates. This step is used to compensate for the distortion errors of the wide-angle lens (barrel distortion). After rectification, points that lie on a straight line in the code coordinate system 16 also lie on a straight line in the rectified image in the coordinate system of the image sensor 15. Instead of a computer-assisted rectification, an optical rectification can also be carried out with a corresponding objective 9, so that substep 340 is optional.

Based on the measured data, the dots are classified in substep 350. Afterwards, in substep 360 the digital code is read in both spatial directions and, with the help of the code table, converted into an integer position indication and a coarse direction indication in 90° steps. The determination of the coarse position in the higher-level step 300 is thus completed.

### Substep 310—Ascertaining the Starting Base

The sequence for determining the starting base 28 is shown in the flow chart FIG. 21.

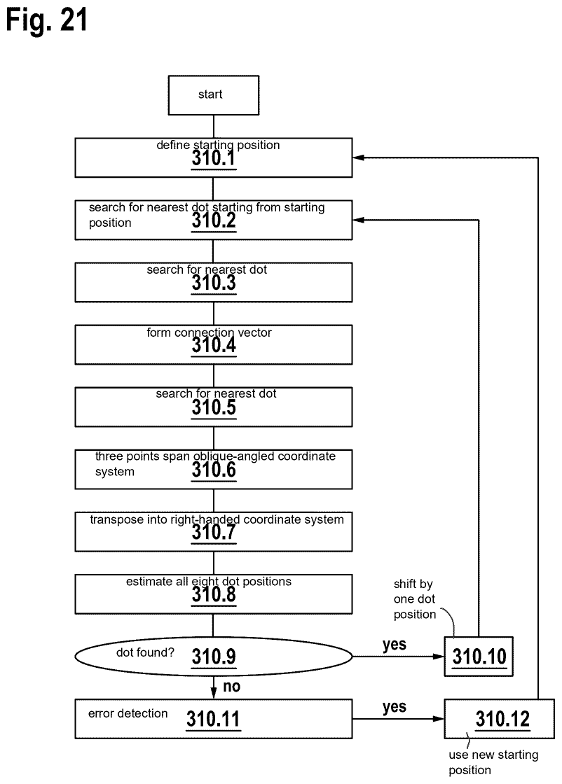

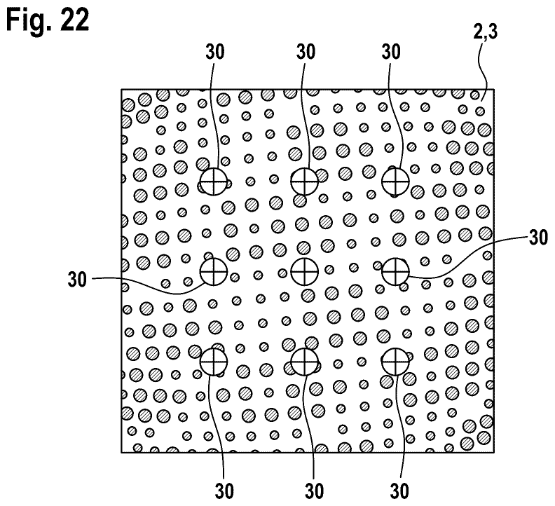

Substep 310.1: First, a starting position 30 is defined to search for the first dot of the starting base 28. FIG. 22 shows a plurality of predefined starting positions 30 in the image field of the camera 1. The search begins at one of these starting positions. If the sequence fails (e.g., due to a disturbance in the image field), a second search is started at the second starting position, and so on, until substep 310.1 can be successfully completed. If all starting positions have been used and no search was successful, substep 310.1 is aborted with a negative result.

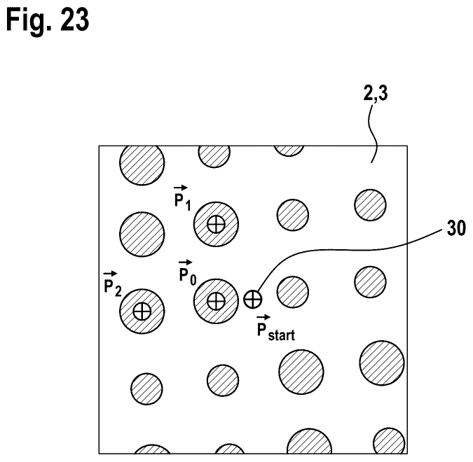

Substep 310.2: Starting from the starting position \vec{P}_{Start}/30, the nearest dot is searched for. In FIG. 23 a dot at position \vec{P}₀ is found as starting base symbol.

Substep 310.3: Then, starting from \vec{P}₀, the nearest dot is searched for and, with \vec{P}₁, designated as the first auxiliary starting base symbol.

Substep 310.4: Next, a connection vector \vec{E}₁=(\vec{P}₁−\vec{P}₀) is formed.

Substep 310.5: Starting from \vec{P}₀, the nearest dot in the orthogonal direction to the connection vector \vec{E}₁=(\vec{P}₁−\vec{P}₀) is searched for and is designated with \vec{P}₂ as the second auxiliary starting base symbol.

Substep 310.6: The three points \vec{P}₀, \vec{P}₁ and \vec{P}₂ span an oblique-angled coordinate system with the axes \vec{E}₁=(\vec{P}₁−\vec{P}₀) and \vec{E}₂=(\vec{P}₂−\vec{P}₀), where \vec{P}₀ forms the origin of the coordinate system.

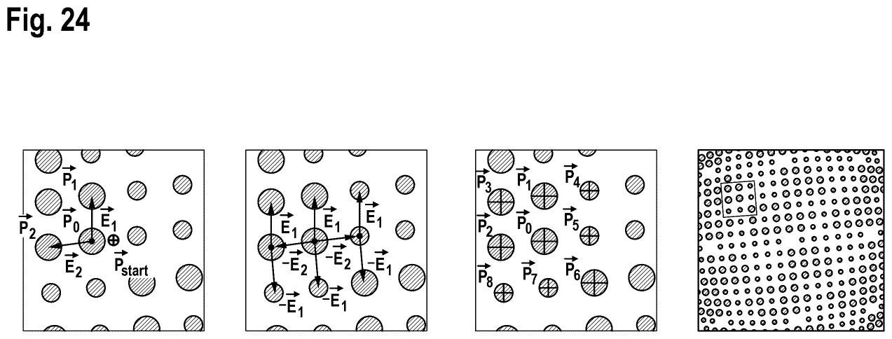

Substep 310.7: If the coordinate system is left-handed (condition: (\vec{E}₁×\vec{E}₂)<0), it is transposed into a right-handed coordinate system by exchanging the axes \vec{E}₁ and \vec{E}₂; see FIG. 24, left.

Substep 310.8: By linear combination of the vectors \vec{E}₁ and \vec{E}₂, all eight dot positions adjacent to \vec{P}₀ are estimated (FIG. 24, second from left) and used as the starting field 28 for searching and measuring dots. As a result, a starting base 28 of 3×3 dots is available (FIG. 24, second from right, right).

Substep 310.9: If a dot is not found during this sequence, it is assumed that it is a parcel symbol 21 (missing dot).

In substep 310.10, \vec{P}₀ is then shifted by one dot position in the direction opposite to the missing dot and the sequence continues with the new search of \vec{P}₁ and \vec{P}₂. In the second run, it is to be assumed that all 3×3 dots are identified, since the next parcel symbol 21 is one parcel 19 away (here: 7 dots) and the starting base is only 3×3 dots in size.

Subsequently, a substep 310.11 can be carried out for error detection, wherein if an error is detected in a substep 310.12, a new starting position 30 is used and the procedure is repeated starting from substep 310.2.

As part of the previously described sequence, the challenge is to identify a dot in the image field of the camera 1 starting from an estimated starting position and to measure its position and area with sub-pixel accuracy. In order to achieve a short measuring time, this sequence must be carried out very quickly, since a total of 225 dots must be identified in a reading field 22.

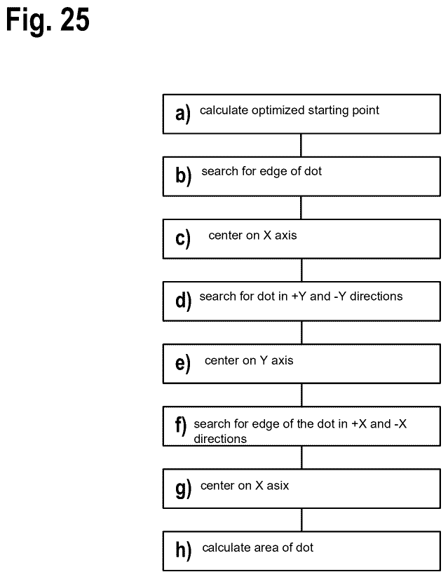

For this purpose, the function Center_Pos (described below) is used, which is optimized for a minimum number of pixel accesses. FIG. 25 shows the flow chart.

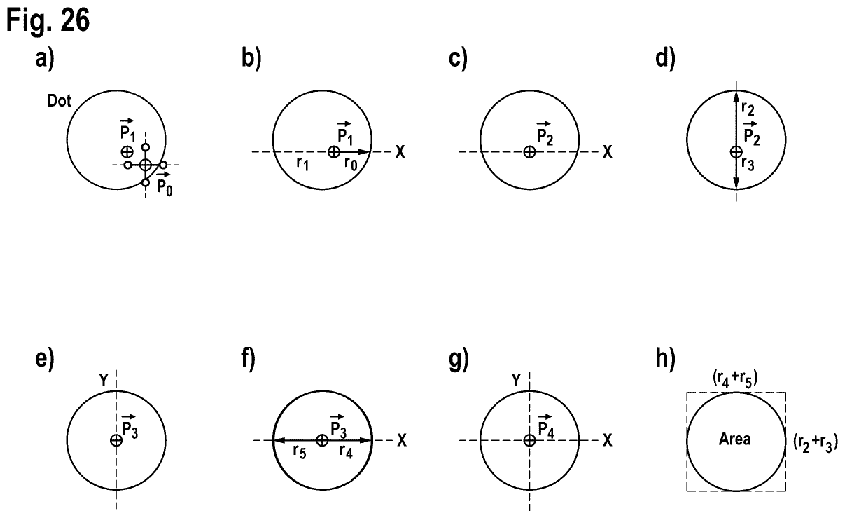

When the function Center_Pos is called, the estimated center point position of the dot \vec{P}₀ is transferred. If \vec{P}₀ is outside the search area, the search is aborted and a negative result is returned. Otherwise, the 8 steps a)-h) are carried out; see also FIG. 26 a-h:
a) Using a gray-value-based two-dimensional gradient method, from \vec{P}₀ an optimized starting point \vec{P}₁ is calculated which is closer to the center of the dot. To calculate the gradient, only 4 pixel accesses are required in the environment of the starting point \vec{P}₀.
b) Starting from the optimized point \vec{P}₁, the edge of the dot is searched for in the +X and −X directions using edge detection methods. The distance from \vec{P}₁ to the right edge is r₀, and to the left edge is r₁.
c) \vec{P}₁ is centered on the X axis with respect to the left and right edge, resulting in the optimized point \vec{P}₂.
d) Starting from the point \vec{P}₂, the edge of the dot is searched for in the +Y and −Y directions using edge detection methods. The distance from \vec{P}₂ to the top edge is r₂, and to the bottom edge is r₃.
e) \vec{P}₂ is centered on the Y axis with respect to the top and bottom edge, resulting in the optimized point \vec{P}₃.
f) Starting from the point \vec{P}₃, the edge of the dot is searched for again in the +X and −X directions using edge detection methods. The distance from \vec{P}₃ to the right edge is r₄, and to the left edge is r₅.
g) \vec{P}₃ is centered on the X axis with respect to the left and right edge. This results in the optimized point \vec{P}₄, which is output as the center point position of the dot with sub-pixel accuracy.
h) The area of the dot is calculated as the area of the circumscribing rectangle, multiplied by the factor π/4 to convert the square area into a circular area or elliptical area:

$$Dot . Area = ( {r}_{2} + {r}_{3} ) \cdot ( {r}_{4} + {r}_{5} ) \cdot \frac{π}{4}$$

As part of the previously described sequence, there is also the challenge of finding in the camera image 3 the dot closest to a starting position \vec{P}₀. This task can be accomplished using the following Nearest_dot function. The function receives the input data

| | |
|---|---|
| \vec{P}₀ | Starting position |
| rₘᵢₙ | Minimum search radius |
| rₘₐₓ | Maximum search radius |
| ND | Boolean variable (ND = “neighbor dot”): |

If the starting position is within a dot and ND=false, the dot is output at the location of the starting position. If ND=true, the dot at the starting position is ignored and the nearest neighbor dot is output.

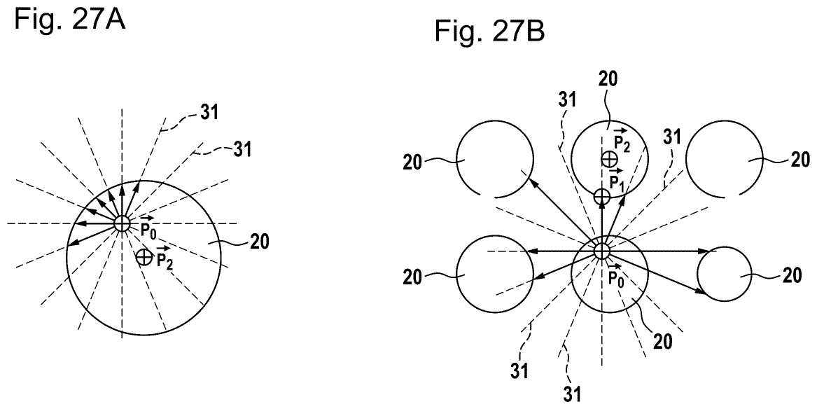

Starting from the starting point \vec{P}₀, the function scans the image field along 16 search beams 31 at an angular distance of 22.5° (FIG. 27a, b). The radius of all search beams 31 is increased in steps, starting with the radius rₘᵢₙ, up to the maximum radius rₘₐₓ.

If ND=false (FIG. 27a), edges leading into a dot as well as edges leading out of a dot are searched for. If ND=true (FIG. 27b), only edges that lead into a dot are searched for. As soon as an edge is found, the search is aborted. The edge is located at the position \vec{P}₁, it belongs to the sought nearest dot. Starting from \vec{P}₁, the Center Dot function is used to determine and output the center point position and the area of the found dot.

### Substep 320—Detecting the Dots in the Reading Field

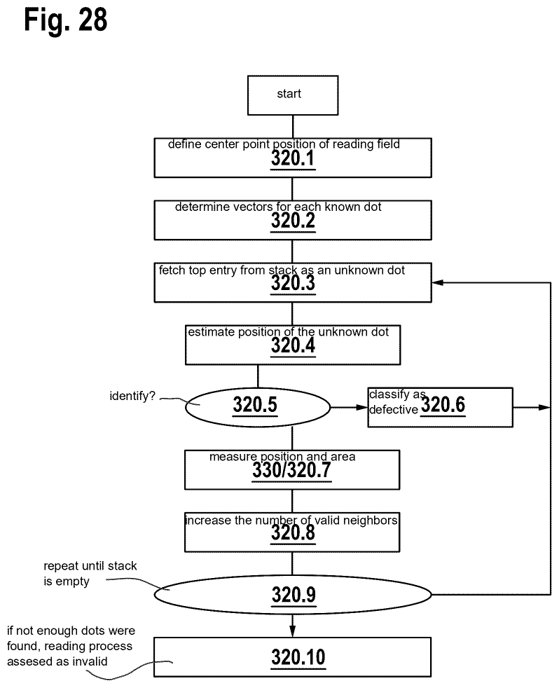

The flow chart in FIG. 28 shows the sequence for detecting all dots in the reading field 22. The previously ascertained starting base 28 of, for example, 3×3 dots serves as input information. In addition, step 330: precise measurement of the center point position and area of the dots is integrated into substep 320.

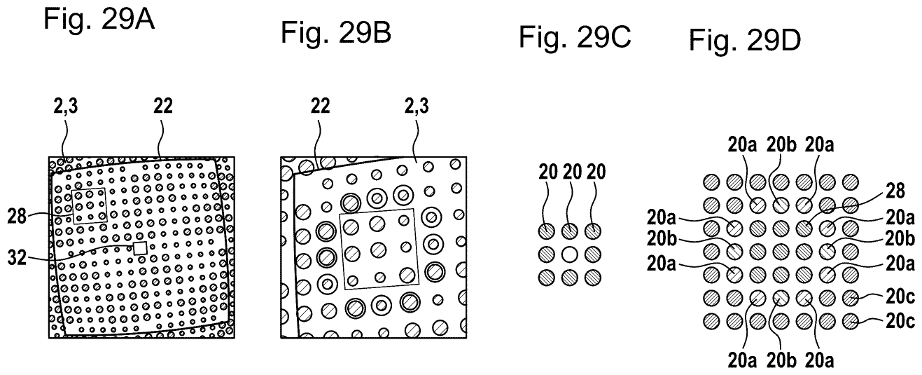

In the first substep 320.1, the center point position 32 of the reading field 22 is defined. This is selected so that the reading field 22 has the greatest possible coverage with the image region in which the code is displayed, so that as many valid dots as possible can be detected. This is usually the case when the center point of the reading field 22 is in the center point of the code region. If the code region occupies the entire image area, as in the present example, the center point position 32 of the reading field is placed as close as possible to the image center point (see FIG. 29a).

At the beginning of the method, only the 3×3 dots of the starting base 28 are known. All other dots in the reading field 22 are still unknown, i.e., their exact position and area have not yet been measured. The aim of the method is to gradually measure and classify the unknown dots.

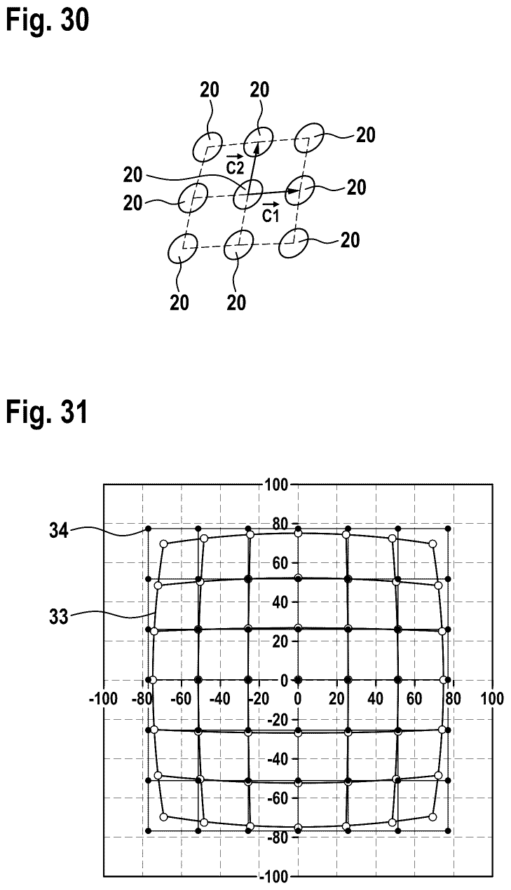

Substep 320.2: For each known dot, the vectors Dot.\vec{C}₁ and Dot.\vec{C}₂ are determined (FIG. 30) that point to, in each case, the nearest neighboring dot in the main axis directions 1 and 2. Due to perspective distortion, they span an oblique-angled coordinate system. By linear combination of the vectors Dot.\vec{C}₁ and Dot.\vec{C}₂, the grid positions of the unknown adjacent dots can be estimated. The position estimation for an unknown dot can be improved by extrapolating and averaging the estimated value from a plurality of valid neighbors.

The more valid neighbors an unknown dot has, the better its position can be estimated. To increase the reliability of the reading process, only unknown dots that have at least two valid neighbors are examined.

For each unknown dot, the number of valid neighbors is counted. This number can be between 0 and 8 (see FIG. 29c): the middle dot position has 8 neighboring positions (dark).

At the beginning of the search, only the 3×3 dots of the starting base are valid. The only unknown dots with 2 or more valid neighbors are highlighted in FIG. 29b). FIG. 29 d) schematically shows the unknown dots with two valid neighbors (20 a) and with three valid neighbors (20 b). All other unknown dots (20 c) do not yet have valid neighbors.

The algorithm is based on a stack, where in substep 320.3 all unknown dots with at least 2 valid neighbors are entered into the stack.

The stack is processed in a loop:
Substep 320.3: The top entry is fetched from the stack as an unknown dot and processed in the following steps.
Substep 320.4: The position of the unknown dot is estimated by averaging the extrapolated positions of all valid neighbors. If the unknown dot lies outside the expected reading field 22, it is not processed further. If the unknown dot lies within the expected reading field 22, it is identified and measured at the estimated position using the Center_Pos function.
Substep 320.5: If the unknown dot cannot be identified, it is classified as defective (substep 320.6) and the next unknown dot is fetched from the stack.
Step 330/Substep 320.7: If the dot has been identified, its position and area are measured using the Center_Pos function and it is entered into the dot matrix 29 as a valid new dot. The vectors Dot.\vec{C}₁ and Dot.\vec{C}₂ for this dot are also calculated and entered.
Substep 320.8: For all 8 neighbors of the new valid dot, the number of valid neighbors is increased by 1. If an unknown dot has two or more valid neighbors, it is placed on the stack for measurement.
Substep 320.9: This sequence is repeated until the stack is empty. All dots of the reading field have then been processed.
Substep 320.10: If not enough dots were found to determine the position, the reading process is assessed as invalid.

### Substep 340—Rectification

Imaging with the wide-angle lens can result in barrel distortion of the image field. Lines of dots that lie on a straight line in the code plane of the code arrangement 2 may in some circumstances lie on a curved line in the camera image 3.

This curvature can be eliminated by a mathematical procedure called rectification. For reasons of computing time, the rectification is only applied to the center point positions 32 of the dots, not to all pixels of the input image. FIG. 31 shows an example of a non-rectified grid (33) and a rectified grid (34).

The center of the distortion \vec{IC} lies at the intersection point of the optical axis 5 with the camera chip of the image sensor 12; when the camera 1 is perfectly mounted, this is usually the center of the camera chip. Otherwise, the center is determined by a one-time calibration of the camera 1. With a second-order polynomial, a position \vec{P} in the image field of the camera 3 is converted into the rectified position \vec{R}:
\vec{R}=(p₀+p₁D+p₂D²)·\vec{D}+\vec{IC} where
\vec{D}=(\vec{P}−\vec{IC}) Position relative to the center of the distortion
D=|\vec{D}| Distance to the center of the distortion

The distortion only changes the length of the vector \vec{D}, not its direction. The polynomial parameters p₀, p₁, p₂ are specific to the objective 9 and are adapted to it in a calibration process. Alternatively, a distortion-free objective 9 can be used.

### Substep 350—Classification of the Dots

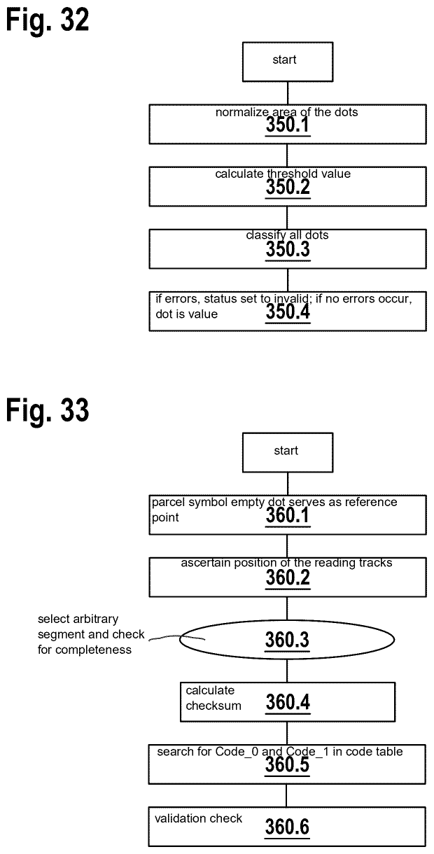

The small and large dots symbolize the values “O” and “1” of the binary number system. The classification of the dots is based on a threshold value for the normalized area of the dots. The sequence is shown in the flow chart in FIG. 32.

Perspective distortion has a strong influence on the area of the dots in the image field. For example, dots that are further away are shown smaller, and circular dots on an inclined plane are shown as an ellipse.

Substep 350.1: To compensate for these effects, the area of the dots is normalized with respect to the area of their dot cell. The dot cell is understood as the parallelogram that is spanned by the vectors Dot.\vec{C}₁ and Dot.\vec{C}₂ at the location of the dot, i.e., the distance vectors from the dot to the adjacent dots in the main axis directions 1 and 2.

FIG. 30 shows a perspectively distorted dot in a distorted grid, which is locally spanned by the vectors Dot.\vec{C}₁ and Dot.\vec{C}₂. The area of the cell is |Dot.\vec{C}₁×Dot.\vec{C}₂|.

The normalized area of the dot is calculated as follows:

$$Dot . {Area}_{scaled} = Dot . Area / \vert Dot . {\vec{C}}_{1} \times Dot . {\vec{C}}_{2} \vert$$

Substep 350.2: the threshold value is calculated using statistical methods from the normalized areas Dot.Area_{scaled} of all dots.

Substep 350.3: all dots are then classified:
Missing Dot: Type 0
Normalized area smaller than threshold: Type 1; otherwise: Type 2.

Substep 350.4: If errors occur, the status is set to invalid; if no errors occur, the dot is valid.

### Substep 360—Reading the Code

After the dots are classified, the dot matrix 29 contains all the information to ascertain the 6D position.

The dot matrix 29 contains the following information:

| | | Data is provided |
|---|---|---|
| | | through the |
| Dot data | Description | following steps: |
| Dot_{i, j}.\vec{P} | Exact dot center | Substep 310 and |
| | points in the | 320, Function: |
| | original image | Center_Pos: sub- |
| | coordinates | pixel-accurate |
| | | detection of the |
| | | dot center |
| Dot_{i, j}.\vec{R} | Dot center points in | Substep 340, |
| | the rectified image | function: rectify: |
| | coordinates | rectification of |
| | | the Dot_{i, j}.\vec{P} |
| Dot_{i, j}.\vec{C1} Dot_{i, j}.\vec{C2} | Local distance vector | Substeps 310 and |
| | between adjacent dots | 320, calculated |
| | in the first and | from the dot center |
| | second grid | points in the |
| | direction. | original image |
| | | coordinates Dot_{i, j}.\vec{P} |
| Dot_{i, j}. Area | Dot area in the | Substep 310 and |
| | original image | 320, Center_Pos: |
| | coordinates [pixels] | Dot area detection |
| Dot_{i, j}. Typ | Classified DotType | Substep 340, Dot |
| | | classification |
| | | based on the dot |
| | | area |
| Dot_{i, j}. VN | Number of valid | Substeps 310 and |
| | neighboring dots | 320, counting the |
| | | valid neighbors |

The flow chart of this is shown in FIG. 33. The digital coarse position in X and Y directions is ascertained by reading the X and Y bit strings in the dot matrix.

Substep 360.1: the parcel symbol 21 “empty dot” (type 0) serves as a reference point to identify the position of the bit strings in the dot matrix 29. If a plurality of entries with type 0 are included, these can be checked against each other because the “empty dot” is regularly repeated in the parcel grid (here: 7×7 dots).

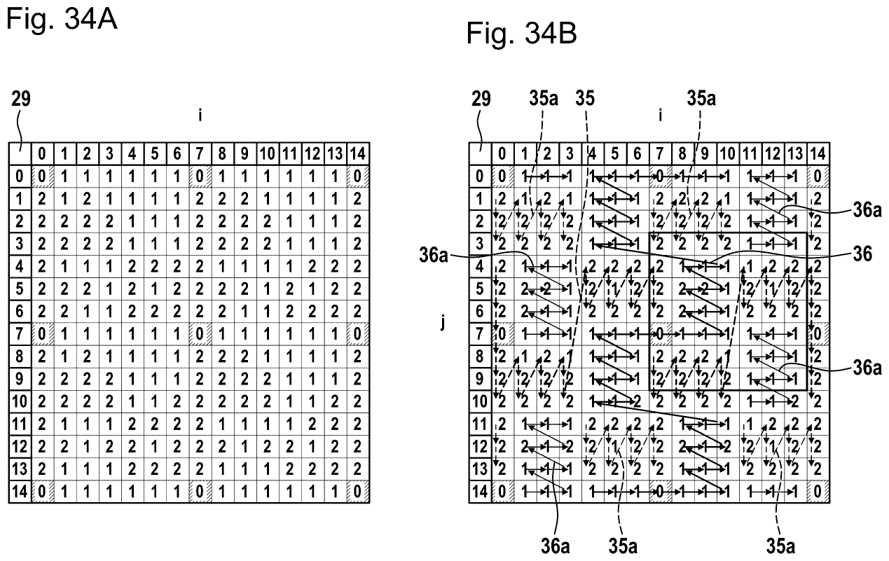

Substep 360.2: Starting from parcel symbol 21, the position of the reading tracks for the codes in the two axes of the code plane is ascertained. It is initially unknown which of the sequences are assigned to the X axis and which to the Y axis and in which direction (forward or backward) the code is read. The codes are read along the reading track and saved as Code_0 and Code_1. FIG. 34a) shows examples of the dot types that are entered in the dot matrix. The parcel symbol (type 0) is highlighted in gray. In FIG. 34b) the reading track for the two axes is also shown. The reading tracks of the two axes are rotated by 90° to each other, with the parcel symbol 21 forming the center of rotation.

Since the reading field (15×15 dots) is significantly larger than a parcel (7×7), the code can be read redundantly: A copy of Code_0 is located in the parcels (35a) adjacent in the j-direction; a copy of Code_1 is located in the parcels (36a) adjacent in the i-direction.

Redundancy also exists in the length of the readable code. To determine the location, a code length of 24 bits in each direction is sufficient, i.e., the content of a 7×7 parcel. However, the larger reading field with 15×15 dots delivers 51 or 54 bits in each direction. The redundant information is used to detect and correct individual incorrectly read bits in Code_0 and Code_1.

In this example, the following codes are read:
Code_0: 111.111.011.111.011.111.111.111.111.111.111.111.011.011.111.111. 111.111
Code_1: 000.000.000.101.000.001.000.000.000.000.100.110.000.000.000.000. 000.000

Substep 360.3: An arbitrary segment with t=24 consecutive bits is selected from Code_0 and checked for completeness.

Substep 360.4: The checksum of Code_0 is then calculated. If this is less than t/2=12, Code_0 is the X code and Code 1 is the Y code. If it is greater than t/2, Code_0 is the Y code and Code_1 is the X code. The Y code is inverted. The X code remains unchanged.

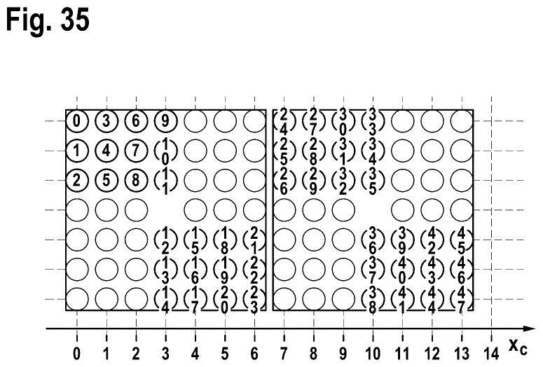

Substep 360.5: Code_0 and Code_1 are then searched for in the code table using an error-tolerant string search. The bit position with the best match is output as the search result; if the deviation is too large, the search result is considered invalid. To transform Code_0 and Code_1 into integer spatial coordinates (X, Y), the bit position of the codes is converted into a spatial position according to the code structure, as shown schematically by way of example in FIG. 35:
An arbitrary segment with t=24 consecutive bits is selected and checked for completeness:
   000100000000001010100000

This is searched for in the code table in the forward direction and is found at bit position 37 as underlined:

0101010100000000100000000001000100000000100000000001010100000 0001000000001000101000000001 . . .
Each X-Dot is assigned a bit position within the code table.
The bit position corresponds to the starting point of the reading order within a parcel.
Each Y-dot is assigned a bit position within the code table.

### 360.6 Validation Check

According to FIG. 35, this corresponds to the dot position Xc=10=Pos₀. In an analogous manner, the Yc value for Posi is ascertained. For both codes, the reading direction (Dir_0 and Dir_1) is also ascertained by searching the codes in both directions in the code table: 0=found in forward direction, 1=found in backward direction. From the reading directions of Code_0 and Code_1, the coarse orientation of the reading window 22 is determined in steps of 90° according to the following table.

Dir₀

| | | 0 | 1 |
|---|---|---|---|
| Dir₁ | 0 | 0° | 270° |
| | 1 | 90° | 180° |

As a result of substep 360, the integer coarse position (r_{X,int}, r_{Y,int}) and the orientation of the reading window 22 are available.

### Step 400—Ascertaining the Beam Data

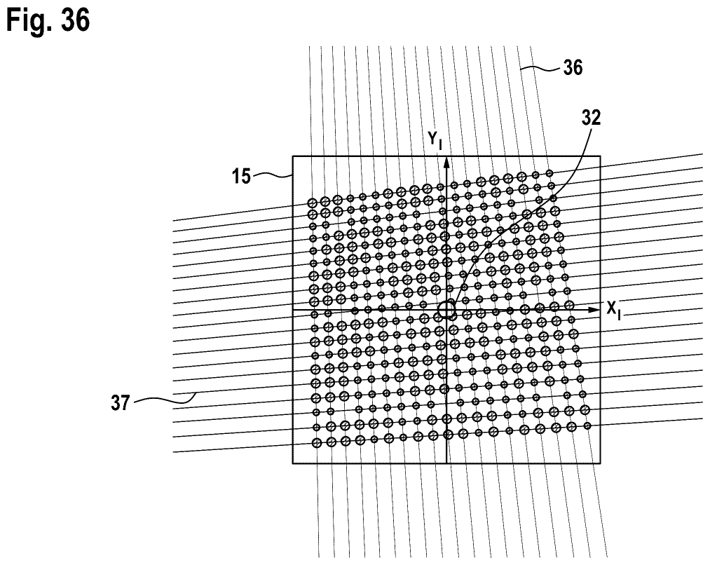

To ascertain the fine position, the rectified position data of the valid dots in the dot matrix 29 are evaluated. FIG. 36 shows an example of the dots of a reading field in the camera image after rectification.

### Step 410: Adapting Best-Fit Lines

For this purpose, best-fit lines (beams) are adjusted to the rows and columns of valid dots in the reading field 22. The best-fit line is calculated using standard mathematical methods to minimize errors from the position data of the valid dots in the relevant row or column. Invalid dots are excluded from the method.

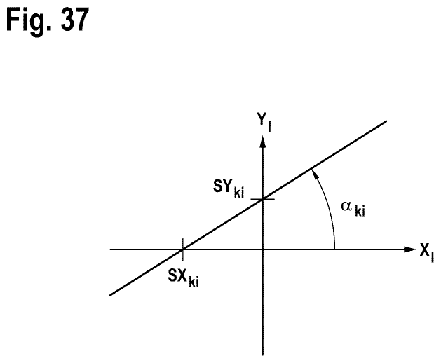

Each best-fit line i of the bunches k=0.1 is described by the following parameters (FIG. 37):

| | |
|---|---|
| SXₖᵢ | Intersection with the X_{I} axis |
| SYₖᵢ | Intersection with the Y_{I} axis |
| αₖᵢ | Angle of the line i in the image field |

The best-fit lines adapted to the dot rows form a first straight line bunch (bunch₀) 36, where the straight lines are parallel to the Y_{C} axis. The straight lines of the dot columns form a second straight line bunch (bunch₁) 37, where the straight lines are parallel to the X_{C} axis. Thus, the position data of 15×15=225 dots are reduced to the data of 15+15=30 best-fit lines.

The interpolation also has the effect of averaging the dot positions on each straight line, so that the best-fit lines are robust against individual fluctuations of the individual dot positions. This increases the stability and accuracy of the 6D position value.

In FIG. 36, the best-fit lines for a reading field with 15×15 dots are shown, the straight lines from bunch₀ as 36 and the straight lines from bunch₁ as 37.

### Step 420—Ascertaining the Bunch Data

In this step, the three straight line parameters SXₖᵢ, SYₖᵢ, αₖᵢ Of each bunch of best-fit lines 36, 37 are interpolated with a second degree polynomial. The interpolation method only considers valid straight lines. Invalid straight lines for which there are too few valid dots available for interpolation are excluded from the bunch interpolation. For this purpose, a weighted interpolation is carried out using standard mathematical methods, based on the minimization of error squares. Valid lines are given a weight of 1.0, while invalid lines are given a weight of 0.0 and are thus hidden.

### Interpolation Function Approach:

$${SX}_{k} ( i ) = {psx}_{k 0} + i \cdot {psx}_{k 1} + {i}^{2} \cdot {psx}_{k 2}$$

$${SY}_{k} ( i ) = {psy}_{k 0} + i \cdot {psy}_{k 1} + {i}^{2} \cdot {psy}_{k 2}$$

$${α}_{k} ( i ) = p {α}_{k 0} + i \cdot p {α}_{k 1} + {i}^{2} \cdot p {α}_{k 2}$$

Here, i is the consecutive number of the straight lines (line index) in the relevant straight line bunch.

### General Approach to Interpolating the Straight Line Parameters:

$${P}_{k} ( i ) = {p}_{k 0} + i \cdot {p}_{k 1} + {i}^{2} \cdot {p}_{k 2} ; where {P}_{k} ( i ) = {SX}_{k} ( i ) , {SY}_{k} ( i ) or {α}_{k} ( i )$$

For a mathematically unique description of a straight line, it is sufficient to indicate only one of the two axis intersection points SXₖᵢ or SYₖᵢ together with the linear angle αₖᵢ. Ideally, the intersection point is specified with the axis that is as perpendicular as possible to the straight line: for shallow straight lines, the intersection point with the Y axis is preferably specified, and for steep straight lines, the intersection point with the X axis is preferably specified. Therefore, the following method is applied:
In bunch 1, a reference straight line is selected which is located close to the center point 32 of the reading field 22.
If the angle of the reference straight lines is in the range

$$[ \frac{- 1}{4} π , \frac{1}{4} π ] or [ \frac{3}{4} π , \frac{5}{4} π ]$$

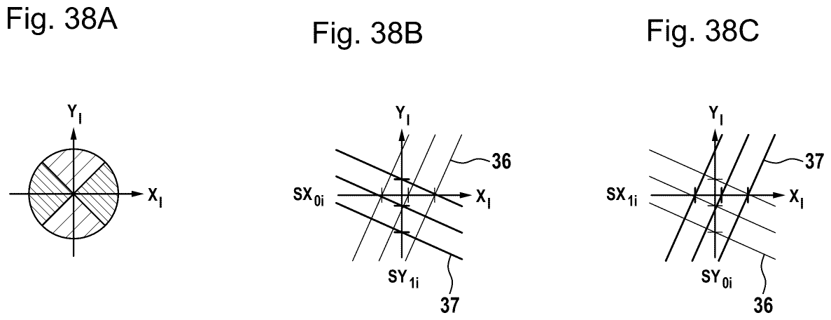

(sectors on the X_{I} axis in FIG. 38a)), it is a shallow straight line. Then for all straight lines in bunch 0 (36), the intersection point SX_{Oi} with the X axis, and for all straight lines in bunch 1 (37) the intersection point SY₁ᵢ with the Y axis, is specified (FIG. 38b)). As a marker, rot_status is set to 0.
If the angle of the reference straight lines is outside the specified range (sectors on the _{I} axis in FIG. 38 a)), it is a steep straight line. Then for all straight lines in bunch 0 (36) the intersection point SY₀ᵢ with the Y axis, and for all straight lines in bunch 1 (37) the intersection point SX₁ᵢ with the X axis, is specified (FIG. 38c)). As a marker, rot_status is set to 1.

This step further reduces the data volume: a bunch of straight lines is described by only 6 parameters, three parameters for αₖᵢ and three parameters for one of the axis intersection points, SXₖᵢ or SYₖᵢ. For two bunches there are 12 parameters plus the marker rot_status.

Thus, two bunches 36, 37 are always described by 12 parameters and the Boolean variable rot_status, independent of the number of straight lines or the size of the measuring field. In the next step, the 6D position is calculated from these parameters.

The interpolation also has the effect that an averaging is carried out over the straight lines of each bunch and thus over all dots, so that the interpolated values are robust against individual fluctuations of individual straight lines or dots. This increases the stability and accuracy of the 6D position value.

### Step 6—Calculating the 6D Camera Position

From the 12 interpolation parameters of the straight line bunches (Table 9.1), the 6 coordinates of the camera position are calculated in the following order:
Substep 500: Position r_{X} and r_{Y}
Substep 710: Calculation of characteristic values of the distorted grid
Substep 600: Camera angle φ_{Z}
Substep 700: Position r_{Z}
Substep 700: Camera angle φ_{X} and φ_{Y}
Substep 700: Iterative algorithm for solving the system of equations for φ_{X}, φ_{Y} and r_{Z}

The calculation includes the derivation of characteristic values that describe the measured grid at the location of the optical axis 5. These characteristic values are linked to the 6D camera position via a system of equations that results from the imaging model and the laws of geometrical optics.

The camera position is determined by solving the system of equations.

In addition, the validity of the position values is estimated by evaluating a large number of diagnostic results from the individual steps of the program sequence.

Substep 500—Calculating the Camera Position r_{X} and r_{Y}

The camera position in X and Y is calculated as the sum of the integer coarse position (r_{X,int}, r_{Y,int}) and a real fraction [0 . . . 1] (fine position), multiplied by the dot grid spacing:
r_{X}=(r_{X,int}+r_{X,fract})·c_{grid}; Unit: [m]
r_{Y}=(r_{Y,int}+r_{Y,fract})·c_{grid}; Unit: [m]
where (r_{X,int}, r_{Y,int}): Integer position of the reading field in [dot], as ascertained in step 300
(r_{X,fract}, r_{Y,fract}): real fraction of the reading field position in [dot]
c_{grid}: Dot grid spacing in [m/dot].

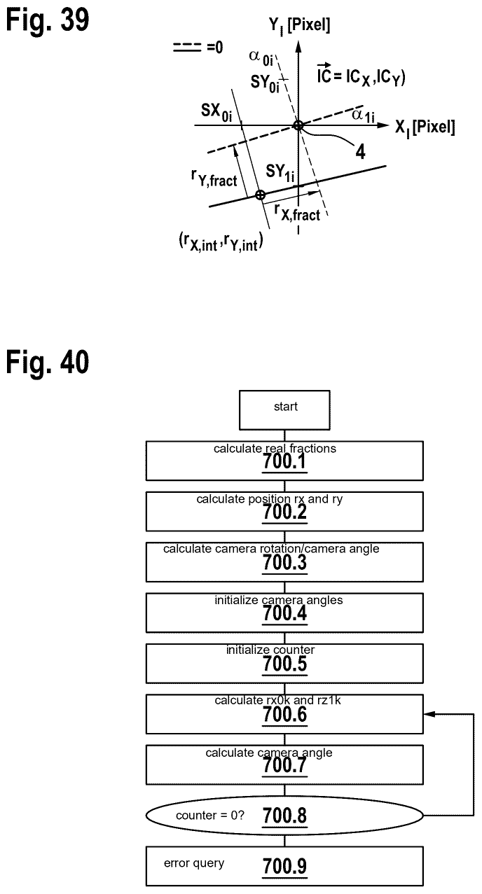

The reference point for measuring the camera position is the intersection point 4 of the optical axis 5 with the code arrangement 2, and in the camera image 3 is the intersection point of the optical axis 5 with the image sensor 12 (FIG. 2, point (4) or imaging of the intersection point 4 (image center point 4 in FIG. 39)). This image center point IC (4) is determined by the position of the objective 9 in relation to the camera chip; it does not have to be identical to the center of the camera chip. It is ascertained in a calibration process and is stored as a constant two-dimensional vector (IC_{X}, IC_{Y}) in the program. The fractions r_{X,fract} and r_{Y,fract} are calculated as the intersection point of the interpolated straight line with the image center point 4. For the two beams k=0 and k=1 (36, 37) the interpolation equation for the axis intersection point applies:

Sₖ(i)=pSₖ₀+i·psₖ₁+i²·psₖ₂; where Sₖ(i)=SXₖ(i) or SYₖ(i), depending on rot_status.

In FIG. 39 the center point lines for both straight line bunches k=0 and k=1 are shown.

The following applies:
for rot_status=0:

$$( \begin{matrix}{S}_{0} ( {r}_{X , fract} ) \\ {S}_{1} ( {r}_{Y , fract} )\end{matrix} ) = ( \begin{matrix}{IC}_{X} \\ {IC}_{Y}\end{matrix} )$$

for rot_status=1:

$$( \begin{matrix}{S}_{0} ( {r}_{X , fract} ) \\ {S}_{1} ( {r}_{Y , fract} )\end{matrix} ) = ( \begin{matrix}{IC}_{Y} \\ {IC}_{X}\end{matrix} )$$

By appropriate choice of interpolation parameters (i,j), the axis intersection point for both center point lines is shifted to the image center point \vec{IC}. This is fulfilled by the equations
for straight line bunch 0:

$${r}_{X , fract}^{2} + {r}_{X , fract} \cdot \frac{{ps}_{01}}{{ps}_{02}} + \frac{( {ps}_{00} - {T}_{X} )}{{ps}_{02}} = 0$$

for straight line bunch 1:

$${r}_{Y , fract}^{2} + {r}_{Y , fract} \cdot \frac{{ps}_{11}}{{ps}_{12}} + \frac{( {ps}_{10} - {T}_{Y} )}{{ps}_{12}} = 0$$

where

$$( {T}_{X} , {T}_{Y} ) = \{ \begin{matrix}( {IC}_{X} , {IC}_{Y} ) for rot\_status = 0 \\ ( {IC}_{Y} , {IC}_{X} ) for rot\_status = 1\end{matrix}$$

The solution of the equations leads to the desired fractions of the straight line indices r_{X,fract} and r_{Y,fract}:

$${r}_{X , fract} = \frac{- 1}{2 \cdot {ps}_{02}} ( sign ( {ps}_{01} ) \cdot \sqrt{{ps}_{01}^{2} - 4 \cdot {ps}_{02} \cdot ( {ps}_{00} - {T}_{X} )} - {ps}_{01} )$$

$${r}_{Y , fract} = \frac{- 1}{2 \cdot {ps}_{12}} ( sign ( {ps}_{11} ) \cdot \sqrt{{ps}_{11}^{2} - 4 \cdot {ps}_{012} \cdot ( {ps}_{10} - {T}_{Y} )} - {ps}_{11} )$$

### Substep 710—Calculation of Characteristic Values of the Distorted Grid

From the interpolation equations, further characteristic values are obtained that characterize the distorted grid. The fine positions r_{X,fract} and r_{Y,fract} are inserted into the interpolation equations to obtain the characteristic values in the image center point. The characteristic values are used to determine the position in the dimensions r_{Z}, φ_{X}, φ_{Y} and φ_{Z}.

a) Grid spacing of the axis intersection points of the straight lines for both straight line bunches: g_{C0}, g_{C1}.

The grid spacing is determined by deriving the interpolation function for the axis intersection point Sₖ(i) with respect to the dimensionless straight line index i at the location of the image center point:

$${for {bunch}_{k} : {g}_{Ck} = {p}_{grind} \cdot \frac{\partial {s}_{k} ( i )}{{\partial }_{i}} \vert}_{i = {r}_{fract}} = {p}_{grid} \cdot ( {ps}_{k 1} + 2 \cdot {r}_{fract} \cdot {ps}_{k 2} )$$

$$where {r}_{fract} = \{ \begin{matrix}{r}_{X , fract} for k = 0 \\ {r}_{Y , fract} for k = 1\end{matrix}$$

b) Linear angle in the image center point: α_{C0}, α_{C1} (see FIG. 37),

results from the interpolation function for the linear angle:

$$for {bunch}_{k} : {α}_{Ck} = {α}_{k} ( {r}_{fract} ) = {α}_{k 0} + {r}_{fract} \cdot {a}_{k 1} + {r}_{fract}^{2} \cdot {a}_{k 2}^{2}$$

c) Angular divergence of the straight line bunches in the image center point: dα_{C0}, dα_{C1}.

This is understood as the angle difference between adjacent straight lines close to the image center point. It results from the derivation of the interpolation function for the linear angle with respect to the dimensionless straight line index i at the location of the image center point:

$$for {bunch}_{k} : d {α}_{C k} = \frac{\partial {α}_{k} ( i )}{{\partial }_{i}} {\vert}_{{}_{{}_{{}_{{}_{i = {r}_{fract}}}}}} = {α}_{k 1} + 2 \cdot {r}_{fract} \cdot {α}_{k 2}$$

### Substep 600—Calculating the Camera Angle φ_{Z}

The linear angle φ_{Z} is ascertained from the imaging equation derived in 2.4.2:

$$( \begin{matrix}{B}_{X} \\ {B}_{Y}\end{matrix} ) = \frac{b}{( {R}_{31} {x}_{0} + {R}_{32} {y}_{0} + {r}_{Z} )} \cdot ( \begin{matrix}{R}_{11} {x}_{0} + {R}_{12} {y}_{0} \\ {R}_{21} {x}_{0} + {R}_{22} {y}_{0}\end{matrix} ) ;$$

where r_{Z}=z₀−b: Distance code plane/opt. center

By deriving the image coordinates B_{X} and B_{Y} with respect to the code grid coordinate x₀ the following is obtained:

$$\frac{\partial {B}_{X}}{\partial {x}_{0}} = b \frac{( {R}_{11} {R}_{32} - {R}_{12} {R}_{31} ) {y}_{0} + {R}_{11} {r}_{Z}}{{( {R}_{31} x + {R}_{32} {y}_{0} + {r}_{Z} )}^{2}} ; \\ \frac{\partial {B}_{Y}}{\partial {x}_{0}} = b \frac{( {R}_{21} {R}_{32} - {R}_{22} {R}_{31} ) {y}_{0} + {R}_{21} {r}_{Z}}{{( {R}_{31} {x}_{0} + {R}_{32} {y}_{0} + {r}_{Z} )}^{2}}$$

The gradient of a straight line in the straight line bunch bunch₁ in the camera image is

$${m}_{1} = \frac{\partial {B}_{Y} / \partial {x}_{0}}{\partial {B}_{X} / \partial {x}_{0}} = b \frac{( {R}_{21} {R}_{32} - {R}_{22} {R}_{31} ) {y}_{0} + {R}_{21} {r}_{Z}}{( {R}_{11} {R}_{32} - {R}_{12} {R}_{31} ) {y}_{0} + {R}_{11} {r}_{Z}} = \frac{( sin {φ}_{X} sin {φ}_{Z} - cos {φ}_{X} sin {φ}_{Y} cos {φ}_{Z} ) \cdot {y}_{0} - cos {φ}_{Y} sin {φ}_{Z} \cdot {r}_{Z}}{( - sin {φ}_{X} cos {φ}_{Z} - cos {φ}_{X} sin {φ}_{Y} sin {φ}_{Z} ) \cdot {y}_{0} + cos {φ}_{Y} cos {φ}_{Z} \cdot {r}_{Z}}$$

Consideration of the gradient in the center with y₀=0 yields m₁|_{y}_{₀}₌₀=−tan(φ_{Z}).

m₁|_{y}_{₀}₌₀ is the gradient of the straight lines from bunch in the image center point. It corresponds to the characteristic value α_{C1} from 6.2 b), i.e., m₁|_{y}_{₀}₌₀=tan(α_{C1}).

This leads to the equation for the camera angle φ_{Z}: φ_{Z}=α_{C1}

### Substep 700—Calculating the Camera Position r_{Z}

The camera position r_{Z} is ascertained from the grid spacing of the axis intersection points g_{Ci} for both straight line bunches bunchᵢ. Since there are two straight line bunches in each image, in principle two r_{Z} positions can be ascertained. For the cases rot_status=k there result four values r_{Zik} where (i,k=0 . . . 1). The imaging equation for FIG. 9 applies:

$$( \begin{matrix}{B}_{X} \\ {B}_{Y}\end{matrix} ) = \frac{b}{( {R}_{31} {x}_{0} + {R}_{32} {y}_{0} + {r}_{Z} )} \cdot ( \begin{matrix}{R}_{11} {x}_{0} + {R}_{12} {y}_{0} \\ {R}_{21} {x}_{0} + {R}_{22} {y}_{0}\end{matrix} ) ;$$

where r_{Z}=b−z₀: distance code plane/opt. center

As an example, the value r_{Z00} is ascertained from the measured grid spacing g_{C0} of the axis intersection points on the B_{X} axis for rot_status=0.

On the By axis the following applies: B_{Y}=0, and from the imaging equation there follows

$${R}_{21} {x}_{0} + {R}_{22} {y}_{0} = 0 ⇒ {y}_{0} = - \frac{{R}_{21}}{{R}_{22}} {x}_{0}$$

Inserting this term into the equation for B_{X} yields

$${B}_{X} = \frac{b \cdot ( {R}_{11} {R}_{22} - {R}_{12} {R}_{21} ) {x}_{0}}{( {R}_{22} {R}_{31} - {R}_{21} {R}_{32} ) {x}_{0} + {R}_{22} {r}_{Z 00}} .$$

The grid spacing g_{C0} corresponds to the derivative

$$\frac{\partial {B}_{X}}{\partial {x}_{0}^{′}}$$

for

$${x}_{0}^{′} = 0 ;$$

where

$${x}_{0}^{′} = \frac{{x}_{0}}{{c}_{grid}}$$

straight line index in [dots]

From this there follows

$$\frac{\partial {B}_{X}}{\partial {x}_{0}^{′}} = \frac{\partial {B}_{X}}{\partial {x}_{0}} \cdot {c}_{grid} = \frac{b \cdot {c}_{grid} \cdot ( {R}_{11} {R}_{22} - {R}_{12} {R}_{21} ) {R}_{22} \cdot {r}_{Z 00}}{{( ( {R}_{22} {R}_{31} - {R}_{21} {R}_{32} ) {x}_{0} + {R}_{22} {r}_{Z 00} )}^{2}}$$

For x₀=0 we obtain

$${{g}_{C 0} = \frac{\partial {B}_{X}}{\partial {x}_{0}^{′}} \vert}_{{x}_{0} = 0} = \frac{b \cdot {c}_{grid} \cdot ( {R}_{11} {R}_{22} - {R}_{12} {R}_{21} )}{{R}_{22} {r}_{Z 00}} ,$$

and, resolved for r_{Z00}:

$${r}_{Z 00} = \frac{b \cdot {c}_{grid} \cdot ( {R}_{11} {R}_{22} - {R}_{12} {R}_{21} )}{{g}_{C 0} \cdot {R}_{22}}$$

By inserting the matrix elements Rᵢⱼ the equation for r_{Z00} is obtained:

$${r}_{Z 00} = \frac{b \cdot {c}_{grid} \cdot cos {φ}_{Y}}{{g}_{C 0} \cdot ( cos {φ}_{Z} - tan {φ}_{X} sin {φ}_{Y} sin {φ}_{Z} )}$$

In the same way, the position r_{Z01} is calculated for rot_status=1, approach:

$${{g}_{C 0} = \frac{\partial {B}_{Y}}{\partial {x}_{0}^{′}} \vert}_{{x}_{0} = 0}$$

The positions r_{Z1k} are derived from g_{C1}, approach for r_{Z10}: g_{C1}=

$${\frac{\partial {B}_{Y}}{\partial {y}_{0}^{′}} \vert}_{{y}_{0} = 0} ;$$

for

$${{r}_{Z 11} : {g}_{C 1} = \frac{\partial {B}_{X}}{\partial {y}_{0}^{′}} \vert}_{{y}_{0} = 0}$$

The results are summarized in Table 10.1.

TABLE
Calculating the camera position values r_{Zik}

| | r_{Z0k} | r_{Z1k} |
|---|---|---|
| rot_status | (derived from bunch₀) | (derived from bunch₁) |
| 0 | ${r}_{Z 00} = \frac{b \cdot {c}_{grid} \cdot {cos φ}_{Y}}{\begin{matrix}{g}_{C 0} \cdot ( {cosφ}_{Z} - \\ {tanφ}_{X} {sinφ}_{Y} {sinφ}_{Z} )\end{matrix}}$ | ${r}_{Z 10} = \frac{b \cdot {c}_{grid} \cdot {cos φ}_{Y}}{{g}_{C 1} \cdot {cosφ}_{Z}}$ |
| 1 | ${r}_{Z 01} = \frac{b \cdot {c}_{grid} \cdot {cos φ}_{Y}}{\begin{matrix}{g}_{C 0} \cdot ( - {sinφ}_{Z} - \\ {tanφ}_{X} {sinφ}_{Y} {cosφ}_{Z} )\end{matrix}}$ | ${r}_{Z 11} = \frac{b \cdot {c}_{grid} \cdot {cos φ}_{Y}}{{g}_{C 1} \cdot {sinφ}_{Z}}$ |

By introducing the angle

$$β = rot\_status \cdot \frac{π}{2}$$

the equations can be summarized:

$${r}_{Z 0 k} = \frac{b \cdot {c}_{grid} \cdot cos {φ}_{Y}}{{g}_{C 0} \cdot ( cos ( {φ}_{Z} + β ) - tan {φ}_{X} sin {φ}_{Y} sin ( {φ}_{Z} + β ) )}$$

$${r}_{Z 1 k} = \frac{b \cdot {c}_{grid} \cdot cos {φ}_{X}}{{g}_{C 1} \cdot cos ( {φ}_{Z} - β )}$$

To output just one value r_{Z} per image, the mean of both z-values is calculated:

$${r}_{Z} = \frac{{r}_{Z 0 k} + {r}_{Z 1 k}}{2}$$

Substep 700—Calculating the Camera Angles φ_{X}, φ_{Y}

The angles φ_{X}, φ_{Y} are derived from the angular divergence

$$\frac{\partial {α}_{k} ( i )}{{\partial }_{i}}$$

of the two straight line bunches bunchₖ in the image center. In step 600 the linear gradient m₁ for the straight line bunch bunch₁ is derived as a function of the straight line index y₀:

$${m}_{1} ( {y}_{0} ) = \frac{( sin {φ}_{X} sin {φ}_{Z} - cos {φ}_{X} sin {φ}_{Y} cos {φ}_{Z} ) \cdot {y}_{0} - cos {φ}_{Y} sin {φ}_{Z} \cdot {r}_{Z}}{( - sin {φ}_{X} cos {φ}_{Z} - cos {φ}_{X} sin {φ}_{Y} sin {φ}_{Z} ) \cdot {y}_{0} + cos {φ}_{Y} cos {φ}_{Z} \cdot {r}_{Z}}$$

From this we calculate the linear angle α₁(y₀)=tan(m₁(y₀)) and differentiate it with respect to

$${y}_{0}^{′} = \frac{{y}_{0}}{{c}_{g r i d}}$$

[dots] to obtain the angular divergence:

$$\frac{\partial {α}_{1} ( {y}_{0} )}{\partial {y}_{0}^{′}} = \frac{\partial {α}_{1} ( {y}_{0} )}{\partial {y}_{0}} \cdot {c}_{g r i d} = \frac{- {c}_{g r i d} \cdot cos {φ}_{X} sin {φ}_{Y} cos {φ}_{Y} \cdot {r}_{Z}}{{( {y}_{0} \cdot sin {φ}_{X} - {r}_{Z} \cdot cos {φ}_{Y} )}^{2} + {y}_{0}^{2} \cdot {cos}^{2} {φ}_{X} {sin}^{2} {φ}_{Y}}$$

In the center of the image y₀=0 the angular divergence is

$$\frac{\partial {α}_{1} ( {y}_{0} )}{\partial {y}_{0}^{′}} {\vert}_{{}_{{}_{{}_{{}_{{y}_{0} = 0}}}}} = \frac{- {c}_{g r i d} \cdot cos {φ}_{X} tan {φ}_{Y}}{{r}_{Z}}$$

Setting this equal to the measured angular divergence dα_{C1} results in the equation for φ_{Y}:

$$tan {φ}_{Y} = \frac{- d {α}_{{C}_{1}} \cdot {r}_{Z}}{{c}_{g r i d} \cdot cos {φ}_{X}}$$

In the same way, the angle φ_{X} results from the gradient m₀ of a straight line in bunch₀. Analogous to the calculation in 600, the following is obtained:

$${m}_{0} ( {x}_{0} ) = \frac{\begin{matrix}( - sin {φ}_{X} sin {φ}_{Z} + cos {φ}_{X} sin {φ}_{Y} cos {φ}_{Z} ) \cdot {x}_{0} + \\ ( cos {φ}_{X} cos {φ}_{Z} - sin {φ}_{X} sin {φ}_{Y} sin {φ}_{Z} ) \cdot {r}_{Z}\end{matrix}}{\begin{matrix}( sin {φ}_{X} cos {φ}_{Z} + cos {φ}_{X} sin {φ}_{Y} sin {φ}_{Z} ) \cdot {x}_{0} + \\ ( cos {φ}_{X} sin {φ}_{Z} + sin {φ}_{X} sin {φ}_{Y} cos {φ}_{Z} ) \cdot {r}_{Z}\end{matrix}}$$

We differentiate the angle α₀(x₀)=tan(m₀(x₀)) with respect to

$${x}_{0}^{′} = \frac{{x}_{0}}{{c}_{g r i d}}$$

and obtain the angle divergence

$$\frac{\partial {α}_{0} ( {x}_{0} )}{\partial {x}_{0}^{′}} = \frac{\partial {α}_{0} ( {x}_{0} )}{\partial {x}_{0}} \cdot {c}_{g r i d} = \frac{- {c}_{g r i d} \cdot sin {φ}_{X} cos {φ}_{X} {cos}^{2} {φ}_{Y} \cdot {r}_{Z}}{{( {x}_{0} + {r}_{Z} \cdot cos {φ}_{X} )}^{2} - {x}_{0}^{2} \cdot {cos}^{2} {φ}_{X}}$$

In the center of the image x₀=0 the angular divergence is

$$\frac{\partial {α}_{1} ( {x}_{0} )}{\partial {x}_{0}^{′}} {\vert}_{{}_{{}_{{}_{{}_{{x}_{0} = 0}}}}} = \frac{- {c}_{g r i d} \cdot {cos}^{2} {φ}_{Y} tan {φ}_{X}}{{r}_{Z}}$$

Setting this equal to the measured angular divergence dα_{C0} results in the equation for φ_{X}:

$$tan {φ}_{X} = \frac{- d {α}_{{C}_{0}} \cdot {r}_{Z}}{{c}_{g r i d} \cdot {cos}^{2} {φ}_{Y}}$$

Substep 700—Iterative Calculation of the Camera Position Z and the Camera Angles φ_{X}, φ_{Y}

Between the functions φ_{X}, φ_{Y} and Z there are mutual dependencies:

$${φ}_{X} = f ( {φ}_{y} , {r}_{Z} ) ; {φ}_{Y} = f ( {φ}_{X} , {r}_{Z} ) ; {r}_{Z} = f ( {φ}_{X} , {φ}_{y} )$$

Therefore, the equations are solved in an iterative process. With each iteration step, the accuracy of the camera position Z and the camera angle φ_{X} and φ_{Y} increases. The algorithm is shown in the flow chart FIG. 40.

Substep 700.1: Calculating the real fractions of the reading field position in [dot]

$$( {r}_{X , fract} , {r}_{Y , fract} )$$

Substep 700.2: Calculating the position rₓ and r_{y}
Substep 700.3: Calculating the camera rotation/camera angle φ_{Z}
Substep 700.4: Initialize the camera angles phix=0; phiy=0
Substep 700.5: Initialize a counter for iterations with e.g., 4
Substep 700.6: Calculation of r_{Z0k} and r_{Z1k} and finally r_{Z}=(r_{Z0k}+r_{Z1k})/2
Substep 700.7: Calculate camera angle phix, phiy
Substep 700.8: Counter=0? Recalculate; otherwise abort the iteration
Substep 700.9: Error query

The algorithm converges quickly; after about 4 iterations the result is sufficiently stable. Finally, the following results are displayed:
Camera position (r_{X}, r_{Y}, r_{Z}).
Camera angle (φ_{X}, φ_{Y}, φ_{Z}).
Validity information

### LIST OF REFERENCE SIGNS

1 Camera
2 Code arrangement
3 Image
4 Intersection point of the optical axis 5 with the code arrangement 2; support point;
5 Optical axis
6 Empty
7 Intersection of the optical axis with the image sensor
8 Objects with at least one code arrangement 2
9 Objective
10 Focal point of the objective 9
11 Focal point of the objective 9
12 Image sensor
13 Optical center of the objective 9
14 Line of sight
15 Coordinate system (X_{I}, Y_{I}) of the image sensor 12 in the plane of the image sensor 12
16 Coordinate system (X_{C}, Y_{C}) of the code arrangement 2 in the plane of the code arrangement 2
17 Coordinate system (X, Y, Z) of camera 1
18 Virtual image plane
19 Parcel
20 Base symbol
21 Parcel symbol
22 Reading field
23 Center point position
24 X parcel regions
25 Y parcel regions
26 Parcel region for additional data
27 Intersection point pattern
28 Starting field/starting base/launch pad
29 Dot matrix
30 Starting positions
31 Search beams
32 Center point position of the reading field 22
33 Non-rectified point grid
34 Rectified point grid
35 Reading track in a first code direction
36 Reading track in a second code direction
37 First straight line bunch/bunch₀
38 Second straight line bunch/bunch₁

1-13. (canceled)

14. A method for ascertaining at least one degree of freedom of a camera relative to a code arrangement from a camera image of the camera, the code arrangement has a point grid with a plurality of base symbols, wherein a coarse position of the base symbols is encoded in the code arrangement, wherein the base symbols define a first main direction, and a second main direction independent of the first main direction, along the point grid, wherein wherein a reference point is arranged in the camera image, wherein the reference point is formed as an intersection point of an optical axis of the camera with the image sensor and/or the camera image, the method comprising the following steps:
determining the following values as characteristic values from the camera image at the reference point:
an angle of rotation of the camera about the optical axis of the camera,
a first local grid spacing of the point grid in the camera image in the first main direction and/or a second local grid spacing of the point grid in the camera image in the second main direction,
a first local angular divergence of the point grid in the camera image in the first main direction, wherein the first local angular divergence describes a difference angle between two adjacent straight lines in the first main direction in the point grid, and
a second local angular divergence of the point grid in the camera image in the second main direction, wherein the second local angular divergence describes the difference angle between two adjacent straight lines in the second main direction in the point grid;
determining, based on the characteristic values, the following three degrees of freedom of the camera relative to the code arrangement:
a distance between the code arrangement and the camera, and
two independent pitch angles of the optical axis to the code arrangement.

15. The method according to claim 14, wherein the characteristic values are inserted into an optical ray model of the camera and the code arrangement, based on the three degrees of freedom, to determine the three degrees of freedom.

16. The method according to claim 14, wherein the reference point is formed as an intersection point of the optical axis of the camera with the image sensor and/or the camera image.

17. The method according to claim 14, characterized in that the first pitch angle is determined using the following equation:
$${φ}_{X} = f ( d {α}_{C 0} ; {r}_{Z} ; {φ}_{Y} )$$
and/or in that the second pitch angle (phiy) is determined using the following equation:
$${φ}_{Y} = f ( d {α}_{C 1} ; {r}_{Z} ; {φ}_{X} )$$
and/or in that the distance between the code arrangement and the camera is determined using one of the following equation:
$${r}_{Z 00 / 1} = f ( {φ}_{Y} ; {ℊ}_{C 0} ; {φ}_{Z} ; {φ}_{X} ) and / or {r}_{Z 0 / 10} = f ( {φ}_{X} ; {ℊ}_{C 1} ; {φ}_{Z} ) .$$

18. The method according to claim 17, wherein the equations for determining the three degrees of freedom is solved iteratively.

19. The method according to claim 14, wherein a base symbol matrix is ascertained from the camera image, wherein a position of the base symbols in the camera image is entered in the base symbol matrix, and wherein, based on the base symbol matrix: (i)
a first linear function with a first function argument is derived in a coordinate system of the camera image for a first straight line, wherein the first straight line is aligned parallel to the first main direction in a coordinate system of the code arrangement, wherein by changing the first function argument, the first straight line is shifted parallel in the coordinate system of the code arrangement in the second main direction, and/or
a second linear function with a second function argument is derived in the coordinate system of the camera image for a second straight line, wherein the second straight line is aligned parallel to the second main direction in the coordinate system of the code arrangement, wherein by changing the second function argument, the second straight line is shifted parallel in the coordinate system of the code arrangement in the first main direction; and
wherein a local angular divergence and/or a local grid spacing is determined from the first and second linear functions.

20. The method according to claim 19, wherein the coarse position of at least one of the base symbols in the code arrangement is ascertained based on the base symbols or a subset tof the base symbols of the base symbol matrix, and a fine position of two degrees of freedom of the camera relative to the code arrangement is ascertained based on the first and second linear functions.

21. The method according to claim 20, wherein a reference point is arranged in the camera image, with a first axis intersection point function in the coordinate system of the camera image of the first straight line, wherein the first straight line in the coordinate system of the code arrangement is aligned parallel to the first main direction of the point grid, with a first function argument, wherein by changing the first function argument the first straight line in the coordinate system of the code arrangement is shifted parallel in the second main direction, wherein, depending on the first function argument, the first axis intersection point function determines a first axis intersection point along a first axis of the coordinate system of the camera image, wherein the first axis passes through the reference point, with a second axis intersection point function in the coordinate system of the camera image from the second straight line, wherein the second straight line in the coordinate system of the code arrangement is aligned parallel to the second main direction, with a second function argument, wherein by changing the second function argument the second straight line in the coordinate system of the code arrangement is shifted parallel in the first main direction, wherein, depending on the second function argument, the second axis intersection point function determines a second axis intersection point along a second axis of the coordinate system of the camera image, wherein the second axis passes through the reference point, wherein based on the first and second axis intersection point functions, the first function argument and the second function argument are determined such that the reference point forms the first and second axis intersection points, wherein based on the first and second function arguments and the coarse position, the fine position of the reference point in the coordinate system of the code arrangement in the plane of the code arrangement is determined as at least one further degree of freedom.

22. The method according to claim 19, wherein the first and/or the second function argument is determined such that the first and/or the second straight line intersect the reference point, wherein an angle of rotation of the camera about the optical axis is derived as a degree of freedom of the camera relative to the code arrangement based on the first and/or the second straight line.

23. The method according to 14, wherein a starting field is determined with base symbols, wherein the starting field has at least three base symbols, wherein two independent main directions along the point grid in the camera image are estimated via the base symbols of the starting field, wherein the base symbols of the starting field form valid base symbols, wherein in a search step, starting from at least one valid base symbol, additional base symbols are searched for along at least one of the main directions, and wherein, when the search is successful, the further base symbols are identified as valid base symbols wherein the search step is carried out multiple times, wherein the base symbol matrix is ascertained based on the valid base symbols or a subset of the valid base symbols.

24. An electronic control unit or automation assembly having the electronic control unit, wherein the control unit comprises programming and/or circuitry to carry out a method for ascertaining at least one degree of freedom of a camera relative to a code arrangement from a camera image of the camera, the code arrangement has a point grid with a plurality of base symbols, wherein a coarse position of the base symbols is encoded in the code arrangement, wherein the base symbols define a first main direction, and a second main direction independent of the first main direction, along the point grid, wherein a reference point is arranged in the camera image, wherein the reference point is formed as an intersection point of an optical axis of the camera with the image sensor and/or the camera image, the method including the following steps:
determining the following values as characteristic values from the camera image at the reference point:
an angle of rotation of the camera about the optical axis of the camera,
a first local grid spacing of the point grid in the camera image in the first main direction and/or a second local grid spacing of the point grid in the camera image in the second main direction,
a first local angular divergence of the point grid in the camera image in the first main direction, wherein the first local angular divergence describes a difference angle between two adjacent straight lines in the first main direction in the point grid, and
a second local angular divergence of the point grid in the camera image in the second main direction, wherein the second local angular divergence describes the difference angle between two adjacent straight lines in the second main direction in the point grid;
determining, based on the characteristic values, the following three degrees of freedom of the camera relative to the code arrangement:
a distance between the code arrangement and the camera, and
two independent pitch angles of the optical axis to the code arrangement.

25. A non-transitory machine-readable storage medium on which is stored a computer program for ascertaining at least one degree of freedom of a camera relative to a code arrangement from a camera image of the camera, the code arrangement has a point grid with a plurality of base symbols, wherein a coarse position of the base symbols is encoded in the code arrangement, wherein the base symbols define a first main direction, and a second main direction independent of the first main direction, along the point grid, wherein wherein a reference point is arranged in the camera image, wherein the reference point is formed as an intersection point of an optical axis of the camera with the image sensor and/or the camera image, the computer program, when executed by a computer, causing the computer to perform the following steps:
determining the following values as characteristic values from the camera image at the reference point:
an angle of rotation of the camera about the optical axis of the camera,
a first local grid spacing of the point grid in the camera image in the first main direction and/or a second local grid spacing of the point grid in the camera image in the second main direction,
a first local angular divergence of the point grid in the camera image in the first main direction, wherein the first local angular divergence describes a difference angle between two adjacent straight lines in the first main direction in the point grid, and
a second local angular divergence of the point grid in the camera image in the second main direction, wherein the second local angular divergence describes the difference angle between two adjacent straight lines in the second main direction in the point grid;
determining, based on the characteristic values, the following three degrees of freedom of the camera relative to the code arrangement:
a distance between the code arrangement and the camera, and
two independent pitch angles of the optical axis to the code arrangement.
